(19) United States
(12) Patent Application Publication
(10) Pub. No.: US 2025/0133575 A1
(43) Pub. Date: Apr. 24, 2025

(54) SYSTEMS AND METHODS FOR A MULTI-LINK SERVING CELL

(71) Applicant: Huawei Technologies Co., Ltd., Shenzhen (CN)

(72) Inventors: Amine Maaref, Ottawa (CA); Jianglei Ma, Ottawa (CA)

(21) Appl. No.: 18/949,634

(22) Filed: Nov. 15, 2024

Related U.S. Application Data
(63) Continuation of application No. PCT/CN2022/093939, filed on May 19, 2022.

(51) Int. Cl. H04W 72/232; H04L 5/00

(52) U.S. Cl. CPC H04W 72/232; H04L 5/0044; H04L 5/0094

(57) ABSTRACT

Aspects of the present application relate to a multi-link and/or multi-carrier serving cell. Within the multi-link serving cell, uplink carriers and downlink carriers in paired spectrum or unpaired spectrum may be decoupled from each other and or may be shared across different link-types. Multiple downlink carriers may be configured within a single cell (i.e., within a single, multi-carrier cell) and each uplink carrier may be associated with, or linked to, multiple downlink carriers.

### CROSS-REFERENCE TO RELATED APPLICATIONS

This application is a continuation of International Application No. PCT/CN2022/093939, filed on May 19, 2022, which is hereby incorporated by reference in its entirety.

### TECHNICAL FIELD

The present disclosure relates, generally, to wireless network operation and, in particular embodiments, to systems and methods for a multi-link serving cell.

### BACKGROUND

It may be considered that the term “non-terrestrial networks” refers to networks, or segments of networks, using an airborne or spaceborne vehicle for transmission. Spaceborne vehicles include Satellites, including Low Earth Orbiting (LEO) satellites, Medium Earth Orbiting (MEO) satellites, Geostationary Earth Orbiting (GEO) satellites and Highly Elliptical Orbiting (HEO) satellites.

Airborne vehicles include High Altitude Platforms (HAPs) encompassing Unmanned Aircraft Systems (UAS) including: Lighter than Air UAS (LTA); and Heavier than Air UAS (HTA). These UASs operate in altitudes typically between 8 and 50 km, quasi-stationary.

Terrestrial networks (TNs) include conventional cellular networks such as New Radio (NR), Long Term Evolution (LTE), etc. Airborne transmit-receive points (“TRPs” typically at 100 m altitude) can be deployed on-board UAV/drone-type vehicles and can typically be considered part of a TN or an NTN, depending on whether the airborne TRP connects to a core network directly or through an NTN.

It may be considered that many use case scenarios call for multi-connectivity between TN and NTN. One example use case scenario is a big-event with ad hoc, on-demand facilities in an underserved area. Other use case scenarios may be found in urban and sub-urban environments. Another use case scenario relates to serving passengers on board public transport vehicles (e.g., high-speed/regular train, bus, boat). It should be clear that such passengers may benefit from NTN broadband connectivity combined with TN cellular access.

Carrier aggregation (CA) may be shown to increase throughput, to a mobile terminal, by configuring the mobile terminal to be simultaneously connected with multiple serving cells or component carriers (CCs) of a serving node (e.g., a gNodeB). CA may be shown to enable the mobile terminal to transmit and receive data at multiple frequencies (e.g., cells or component carriers) simultaneously.

In a multi-carrier (terrestrial carrier and non-terrestrial carrier) network, service coverage of a terrestrial cellular network can be extended and a user experience/quality of service can be enhanced. Notably, terrestrial nodes may offer a primary service, whereas non-terrestrial nodes (e.g., nodes that are part of a HAPS/satellite system) may provide global, seamless coverage and flying TRPs (e.g., drones) may allow for an on-demand-based regional service boost. Joint operation of TN and NTN may be implemented to provide a three-dimensional wireless communication system experience to the mobile terminals served by a multi-carrier TN and NTN system.

### SUMMARY

According to aspects of the present application, a plurality of distinct carrier types (e.g., TN carriers and NTN carriers) or link types (e.g., TN links and NTN links) may be used in a single, multi-carrier and/or multi-link serving cell. In some embodiments of the present invention, a one-to-one or one-to-many association between carrier-type and link type may exist (e.g., a TN carrier type may be associated with a TN link type and an NTN carrier type may be associated with an NTN link type).

Wireless device operation in an environment including a plurality of distinct carrier types (e.g., TN carriers and NTN carriers) is known to be accomplished with a multi-cell approach. The multi-cell approach may employ carrier aggregation and/or dual connectivity operation. However, it may be shown that delay problems are associated with carrier aggregation and/or dual connectivity operation in the multi-cell approach.

In the multi-cell approach, after a wireless device gains access to a cell, a carrier aggregation framework establishes a need for adding/releasing or activating component carriers, which may be shown to give rise to latency and overhead.

Quick and efficient access to resources of a multi-carrier cell may be enabled by transmitting RMSI/SIB1 information in one carrier of the multi-carrier cell to indicate an initial UL bandwidth part (BWP) and an initial DL BWP for another carrier of the multi-carrier cell.

Conveniently, a wireless device may dynamically switch between uplink carriers for transmitting a physical uplink shared channel (PUSCH). The wireless device may also multiplex PUSCH and physical uplink control channel (PUCCH) in case the transmissions happen to overlap in the time domain.

Aspects of the present application may be shown to enable carriers of different types (e.g., TN carriers and NTN carriers) to share the same carrier bandwidth.

Furthermore, the single, multi-carrier cell approach may be shown to enable efficient utilization of spectrum resources and dynamic allocation of large bandwidth from different carriers. Conveniently, mobility within a multi-carrier TN/NTN cell may rely upon layer 1 or layer 2 beam management and signaling instead of Layer-3 handover.

When the multi-carrier cell comprises one time division duplexed (TDD) and one frequency division duplexed (FDD) carrier, the delay in uplink of the TDD carrier due to the time division multiplexing between uplink and downlink slots in the TDD carrier can be alleviated since uplink slots in the FDD carrier can be used instead.

According to an aspect of the present disclosure, there is provided a method, for carrying out at a device in a radio resource control connected state, of communicating with a serving cell including at least one carrier of a first carrier type and at least one carrier of a second carrier type. The method includes receiving, from the serving cell in a physical downlink control channel (PDCCH) using resources in a bandwidth part of a first downlink carrier of the first carrier type, either a scheduling assignment for reception of a physical downlink shared channel (PDSCH), the PDSCH using resources in a bandwidth part of a downlink carrier of the second carrier type or a scheduling grant for a transmission of a physical uplink shared channel (PUSCH), the PUSCH using resources in a bandwidth part of an uplink carrier of the second carrier type, wherein the PDCCH includes a field containing an indication of the second carrier type.

Aspects of the present application relate to a field in downlink control information in a control resource set in a shared downlink carrier/bandwidth part. The field, which may be as small as a single bit, may provide an indication informing the mobile terminal about the scheduling type (TN or NTN). From this indication, the mobile terminal may infer several parameters related to the type of PUSCH/PDSCH being scheduled (whether TN or NTN) and apply those parameters for the reception or transmission of the PDSCH/PUSCH.

According to an aspect of the present disclosure, there is provided a device for communicating with a serving cell including at least one carrier of a first carrier type and at least one carrier of a second carrier type. The device includes a memory storing instructions and a processor. The processor is caused, by executing the instructions, to receive, from a serving cell in a physical downlink control channel (PDCCH) using resources in a bandwidth part of a first downlink carrier of the first carrier type, either a scheduling assignment for reception of a physical downlink shared channel (PDSCH), the PDSCH using resources in a bandwidth part of a downlink carrier of the second carrier type or a scheduling grant for a transmission of a physical uplink shared channel (PUSCH), the PUSCH using resources in a bandwidth part of an uplink carrier of the second carrier type. The PDCCH includes a field containing an indication of the second carrier type.

A computer readable medium storing instructions, wherein execution of the instructions, by a processor in a device for communicating with a serving cell including at least one carrier of a first carrier type and at least one carrier of a second carrier type, causes the processor to receive, from a serving cell in a physical downlink control channel (PDCCH) using resources in a bandwidth part of a first downlink carrier of the first carrier type, either a scheduling assignment for reception of a physical downlink shared channel (PDSCH), the PDSCH using resources in a bandwidth part of a downlink carrier of the second carrier type or a scheduling grant for a transmission of a physical uplink shared channel (PUSCH), the PUSCH using resources in a bandwidth part of an uplink carrier of the second carrier type. The PDCCH includes a field containing an indication of the second carrier type.

According to an aspect of the present disclosure, there is provided a method, for carrying out at a device in a radio resource control connected state, of communicating with a multi-carrier serving cell including at least one carrier of a first carrier type and at least one carrier of a second carrier type. The method includes receiving configuration information for a plurality of bandwidth parts, the configuration information specifying a plurality of uplink bandwidth parts of the first carrier type, a plurality of uplink bandwidth parts of the second carrier type, a plurality of downlink bandwidth parts of the first carrier type and a plurality of downlink bandwidth parts of the second carrier type. The method further includes receiving a switching instruction and responsive to the receiving the switching instruction, switching operation from one of the plurality of bandwidth parts to another of the plurality of bandwidth parts.

After a wireless device gains access to a multi-carrier cell, there is no need for adding/releasing or activating component carriers. In comparison to the carrier aggregation framework in the multi-cell approach, the single, multi-carrier cell approach may be shown to reduce latency and reduce overhead.

According to an aspect of the present disclosure, there is provided a device for communicating with a serving cell including at least one carrier of a first carrier type and at least one carrier of a second carrier type. The device includes a memory storing instructions and a processor. The processor is caused, by executing the instructions, to receive configuration information for a plurality of bandwidth parts, the configuration information specifying a plurality of uplink bandwidth parts of the first carrier type, a plurality of uplink bandwidth parts of the second carrier type, a plurality of downlink bandwidth parts of the first carrier type and a plurality of downlink bandwidth parts of the second carrier type. The processor is further caused, by executing the instructions, to receive a switching instruction and switch operation from one of the plurality of bandwidth parts to another of the plurality of bandwidth parts.

According to an aspect of the present disclosure, there is provided a computer readable medium storing instructions, wherein execution of the instructions, by a processor in a device for communicating with a serving cell including at least one carrier of a first carrier type and at least one carrier of a second carrier type, causes the processor to receive configuration information for a plurality of bandwidth parts, the configuration information specifying a plurality of uplink bandwidth parts of the first carrier type, a plurality of uplink bandwidth parts of the second carrier type, a plurality of downlink bandwidth parts of the first carrier type and a plurality of downlink bandwidth parts of the second carrier type. Execution of the instructions further causes the processor to receive a switching instruction and switch operation from one of the plurality of bandwidth parts to another of the plurality of bandwidth parts.

According to an aspect of the present disclosure, there is provided a method, for carrying out at a device in a radio resource control connected state, of communicating with a multi-carrier serving cell including at least one carrier of a first carrier type and at least one carrier of a second carrier type. The method includes detecting a failure for a bandwidth part in a carrier of the first carrier type, selecting a reference signal from a pool of reference signals configured in a carrier of the second carrier type, reporting the selected reference signal to a network entity and communicating with the network entity on a bandwidth part in a carrier of the second carrier type using a directional beam, the directional beam is associated with the selected reference signal.

Aspects of the present application may be shown to enable fast beam failure recovery within the multi-carrier cell on the basis that it is unlikely that beam failure will occur simultaneously in all BWPs/carriers in use by the wireless device in the multi-carrier cell. In situations wherein a multi-carrier carrier comprises an association between a TN carrier and an NTN carrier, efficient and low latency beam failure recovery can be conducted through the TN carrier responsive to the beam link failure occurring in the NTN carrier and vice versa responsive to the beam link failure occurring in the TN carrier.

According to an aspect of the present disclosure, there is provided a device for communicating with a serving cell including at least one carrier of a first carrier type and at least one carrier of a second carrier type. The device includes a memory storing instructions and a processor. The processor is caused, by executing the instructions, to detect a failure for a bandwidth part in a carrier of the first carrier type, select a reference signal from a pool of reference signals configured in a carrier of the second carrier type, report the selected reference signal to a network entity and communicate with the network entity on a bandwidth part in a carrier of the second carrier type using a directional beam, the directional beam is associated with the selected reference signal.

According to an aspect of the present disclosure, there is provided a computer readable medium storing instructions, wherein execution of the instructions, by a processor in a device for communicating with a serving cell including at least one carrier of a first carrier type and at least one carrier of a second carrier type, causes the processor to detect a failure for a bandwidth part in a carrier of the first carrier type, select a reference signal from a pool of reference signals configured in a carrier of the second carrier type, report the selected reference signal to a network entity and communicate with the network entity on a bandwidth part in a carrier of the second carrier type using a directional beam, the directional beam is associated with the selected reference signal.

According to an aspect of the present disclosure, there is provided a method, for carrying out at a device in a radio resource control (RRC) idle state or an RRC inactive state, of accessing a serving cell. The method includes receiving system information in a broadcast signaling message from the serving cell, the system information including an indication that the serving cell is a multi-carrier serving cell including: at least one carrier of a first carrier type; and at least one carrier of a second carrier type. The system information further including a first-carrier-type-specific reference signal received power threshold associated with the first carrier type, a second-carrier-type-specific reference signal received power threshold associated with the second carrier type, a first-carrier-type-specific random access channel configuration associated with the first carrier type and a second-carrier-type-specific random access channel configuration associated with the second carrier type. The method further includes detecting a reference signal for a synchronization signal block in a downlink carrier of the first carrier type, comparing a received power of the reference signal to the first-carrier-type-specific reference signal received power threshold and responsive to a result of the comparing being a determination that the reference signal received power exceeds the first-carrier-type-specific reference signal received power threshold, carrying out an initial access procedure on an uplink carrier.

The single, multi-carrier cell approach may be shown to achieve network-side energy savings and more efficient resource usage because the network side may decide to send system information on a TN carrier or on an NTN carrier, but not on both carriers.

According to an aspect of the present disclosure, there is provided a device for communicating with a serving cell including at least one carrier of a first carrier type and at least one carrier of a second carrier type. The device includes a memory storing instructions and a processor. The processor is caused, by executing the instructions, to receive system information in a broadcast signaling message from the serving cell, the system information including an indication that the serving cell is a multi-carrier serving cell including at least one carrier of a first carrier type and at least one carrier of a second carrier type. The system information further including a first-carrier-type-specific reference signal received power threshold associated with the first carrier type, a second-carrier-type-specific reference signal received power threshold associated with the second carrier type, a first-carrier-type-specific random access channel configuration associated with the first carrier type and a second-carrier-type-specific random access channel configuration associated with the second carrier type. The processor is further caused, by executing the instructions, to detect a reference signal for a synchronization signal block in a downlink carrier of the first carrier type, compare a received power of the reference signal to the first-carrier-type-specific reference signal received power threshold and carry out an initial access procedure on an uplink carrier responsive to a result of the comparing being a determination that the reference signal received power exceeds the first-carrier-type-specific reference signal received power threshold.

According to an aspect of the present disclosure, there is provided a computer readable medium storing instructions, wherein execution of the instructions, by a processor in a device for communicating with a serving cell including at least one carrier of a first carrier type and at least one carrier of a second carrier type, causes the processor to receive system information in a broadcast signaling message from the serving cell, the system information including an indication that the serving cell is a multi-carrier serving cell including at least one carrier of a first carrier type and at least one carrier of a second carrier type. The system information further includes a first-carrier-type-specific reference signal received power threshold associated with the first carrier type, a second-carrier-type-specific reference signal received power threshold associated with the second carrier type, a first-carrier-type-specific random access channel configuration associated with the first carrier type and a second-carrier-type-specific random access channel configuration associated with the second carrier type. The instructions further cause the processor to detect a reference signal for a synchronization signal block in a downlink carrier of the first carrier type, compare a received power of the reference signal to the first-carrier-type-specific reference signal received power threshold and carry out an initial access procedure on an uplink carrier responsive to a result of the comparing being a determination that the reference signal received power exceeds the first-carrier-type-specific reference signal received power threshold.

According to an aspect of the present disclosure, there is provided a method, for carrying out at a device in a radio resource control (RRC) idle state or an RRC inactive state, of establishing a connection with a serving cell. The method includes receiving system information in a broadcast signaling message from the serving cell, the system information including an indication that the serving cell is a multi-carrier serving cell including: at least one carrier of a first carrier type; and at least one carrier of a second carrier type, the at least one carrier of the second carrier type sharing resources with the at least one carrier of the first carrier type. The system information further includes a reference signal received power threshold and a random access channel configuration. The method further includes detecting a reference signal for a synchronization signal block in a downlink carrier, comparing a received power of the reference signal to the reference signal received power threshold and responsive to a result of the comparing being a determination that the reference signal received power exceeds the reference signal received power threshold, carrying out an initial access procedure on an uplink carrier among the at least one carriers of the first carrier type.

According to an aspect of the present disclosure, there is provided a device for establishing a connection with a serving cell. The device includes a memory storing instructions and a processor. The processor is caused, by executing the instructions, to receive system information in a broadcast signaling message from the serving cell, the system information including an indication that the serving cell is a multi-carrier serving cell including at least one carrier of a first carrier type and at least one carrier of a second carrier type, the at least one carrier of the second carrier type sharing resources with the at least one carrier of the first carrier type. The the system information further includes a reference signal received power threshold and a random access channel configuration. The processor is further caused, by executing the instructions, to detect a reference signal for a synchronization signal block in a downlink carrier, compare a received power of the reference signal to the reference signal received power threshold and carry out an initial access procedure on an uplink carrier among the at least one carriers of the first carrier type responsive to a result of the comparing being a determination that the reference signal received power exceeds the reference signal received power threshold.

According to an aspect of the present disclosure, there is provided a computer readable medium storing instructions, wherein execution of the instructions, by a processor in a device for establishing a connection with a serving cell, causes the processor to receive system information in a broadcast signaling message from the serving cell, the system information including an indication that the serving cell is a multi-carrier serving cell including at least one carrier of a first carrier type and at least one carrier of a second carrier type, the at least one carrier of the second carrier type sharing resources with the at least one carrier of the first carrier type. The system information includes a reference signal received power threshold and a random access channel configuration. Execution of the instructions further causes the processor to detect a reference signal for a synchronization signal block in a downlink carrier, compare a received power of the reference signal to the reference signal received power threshold and carry out an initial access procedure on an uplink carrier among the at least one carriers of the first carrier type responsive to a result of the comparing being a determination that the reference signal received power exceeds the reference signal received power threshold.

According to an aspect of the present disclosure, there is provided a method, for carrying out at a device in a radio resource control (RRC) idle state or an RRC inactive state, of accessing a serving cell. The method includes receiving system information from the serving cell, the system information includes an indication that the serving cell is a multi-carrier serving cell including: at least one carrier of a first carrier type; and at least one carrier of a second carrier type. The system information further includes a carrier-type-specific random access channel configuration associated with the first carrier type and a carrier-type-specific random access channel configuration associated with the second carrier type. The method further includes monitoring a common search space for a physical downlink control channel (PDCCH) addressed with a paging Radio Network Temporary Identifier carrying paging information in a control resource set associated with a carrier of the first carrier type, receiving a physical downlink shared channel (PDSCH) scheduled by the PDCCH, the PDSCH carrying a paging message addressed to the device and responsive to receiving the PDSCH, carrying out an initial access procedure on an uplink carrier of the first carrier type or on an uplink carrier of the second carrier type according to the random access channel configuration associated with the same carrier type.

According to an aspect of the present disclosure, there is provided a device for communicating with a serving cell including at least one carrier of a first carrier type and at least one carrier of a second carrier type. The device includes a memory storing instructions and a processor. The processor is caused, by executing the instructions, to receive system information from the serving cell, the system information including an indication that the serving cell is a multi-carrier serving cell including at least one carrier of a first carrier type and at least one carrier of a second carrier type. The system information further includes a carrier-type-specific random access channel configuration associated with the first carrier type and a carrier-type-specific random access channel configuration associated with the second carrier type. The processor is further caused, by executing the instructions, to monitor a common search space for a physical downlink control channel (PDCCH) addressed with a paging Radio Network Temporary Identifier carrying paging information in a control resource set associated with a carrier of the first carrier type, receive a physical downlink shared channel (PDSCH) scheduled by the PDCCH, the PDSCH carrying a paging message addressed to the device and carry out, responsive to receiving the PDSCH, an initial access procedure on an uplink carrier of the first carrier type or on an uplink carrier of the second carrier type according to the random access channel configuration associated with the same carrier type.

According to an aspect of the present disclosure, there is provided a computer readable medium storing instructions, wherein execution of the instructions, by a processor in a device for accessing a serving cell, causes the processor to receive system information from the serving cell, the system information including an indication that the serving cell is a multi-carrier serving cell including at least one carrier of a first carrier type and at least one carrier of a second carrier type. The system information further includes a carrier-type-specific random access channel configuration associated with the first carrier type and a carrier-type-specific random access channel configuration associated with the second carrier type. Execution of the instructions, by the processor, further causes the processor to monitor a common search space for a physical downlink control channel (PDCCH) addressed with a paging Radio Network Temporary Identifier carrying paging information in a control resource set associated with a carrier of the first carrier type, receive a physical downlink shared channel (PDSCH) scheduled by the PDCCH, the PDSCH carrying a paging message addressed to the device and carry out, responsive to receiving the PDSCH, an initial access procedure on an uplink carrier of the first carrier type or on an uplink carrier of the second carrier type according to the random access channel configuration associated with the same carrier type.

According to an aspect of the present disclosure, there is provided a method, for carrying out at a device in a radio resource control (RRC) connected state, of carrying out a scheduled communication in a multi-link servicing cell. The method includes receiving downlink control information (DCI) carrying an indication of resources on which the scheduled communication is to be carried out and receiving a scheduling type indication, the scheduling type indication indicating whether the scheduled communication is to be carried out on a link of a first link type or a link of a second link type.

According to an aspect of the present disclosure, there is provided a device for carrying out a scheduled communication in a multi-link servicing cell. The device includes a memory storing instructions and a processor. The processor is caused, by executing the instructions, to receive downlink control information (DCI) carrying an indication of resources on which the scheduled communication is to be carried out and receive a scheduling type indication, the scheduling type indication indicating whether the scheduled communication is to be carried out on a link of a first link type or a link of a second link type.

According to an aspect of the present disclosure, there is provided a computer readable medium storing instructions, wherein execution of the instructions, by a processor in a device for carrying out a scheduled communication in a multi-link servicing cell, causes the processor to receive downlink control information (DCI) carrying an indication of resources on which the scheduled communication is to be carried out and receive a scheduling type indication, the scheduling type indication indicating whether the scheduled communication is to be carried out on a link of a first link type or a link of a second link type.

According to an aspect of the present disclosure, there is provided a method of communicating with a shared serving cell. The method includes receiving an indication that a resource within the serving cell is shared between a link of a first link type and a link of a second link type, receiving, through signaling, a configuration for a first reference signal for the link of the first link type and a second reference signal for the link of the second link type, receiving a signal, decoding, from the signal and based on detecting the first reference signal, a physical channel associated with the link of the first link type, cancelling, from the signal, the physical channel associated with the link of the first type and decoding, from the signal and based on detecting the second reference signal, a physical channel associated with the link of the second type.

Aspects of the present application enable links of different types (e.g., TN/NTN) to share the same carrier bandwidth. This allows spectrum resources to be used more efficiently, as physical downlink shared channels (PDSCHs) and/or PUSCHs from TN and NTN may overlap on time/frequency/code resources in a shared carrier and the mobile terminal can still try to decode both sets of data using joint reception techniques, given that the PDSCHs may be received, at a user equipment (UE), with a high SNR differential. In this case, the network may indicate a power offset or gap to the UE to help the UE tune or adjust its automatic gain control (AGC) and regulate the received signal strength such that a signal SNR is suitable for proper decoding in order to adequately receive/decode the two superposed or overlapped signals or channels with a certain SNR/power gap differential without inducing signal clipping or nonlinear degradation due to power amplifier limitations.

According to an aspect of the present disclosure, there is provided a device for communicating with a shared serving cell. The device includes a memory storing instructions and a processor. The processor is caused, by executing the instructions, to receive an indication that a resource within the serving cell is shared between a link of a first link type and a link of a second link type, receive, through signaling, a configuration for a first reference signal for the link of the first link type and a second reference signal for the link of the second link type, receive a signal, decode, from the signal and based on detecting the first reference signal, a physical channel associated with the link of the first link type, cancel, from the signal, the physical channel associated with the link of the first type and decode, from the signal and based on detecting the second reference signal, a physical channel associated with the link of the second type.

According to an aspect of the present disclosure, there is provided a computer readable medium storing instructions, wherein execution of the instructions, by a processor in a device for communicating with a shared serving cell, causes the processor to receive an indication that a resource within the serving cell is shared between a link of a first link type and a link of a second link type, receive, through signaling, a configuration for a first reference signal for the link of the first link type and a second reference signal for the link of the second link type, receive a signal, decode, from the signal and based on detecting the first reference signal, a physical channel associated with the link of the first link type, cancel, from the signal, the physical channel associated with the link of the first type and decode, from the signal and based on detecting the second reference signal, a physical channel associated with the link of the second type.

According to an aspect of the present disclosure, there is provided a method, for carrying out at a device. The method includes receiving a control signal indicating a parameter related to a link of a first link type, determining, based on the parameter, a subset of resources among a set of resources in a shared resource, the subset of resources reserved for carrying physical signals or channels associated with the first link type and declared as not available to carry physical signals or channels associated with a second link type and receiving a downlink signal associated with a link of the second link type, over the set of resources, excluding the subset of resources.

According to an aspect of the present disclosure, there is provided a device. The device includes a memory storing instructions and a processor. The processor is caused, by executing the instructions, to receive a control signal indicating a parameter related to a link of a first link type, determine, based on the parameter, a subset of resources among a set of resources in a shared resource, the subset of resources reserved for carrying physical signals or channels associated with the first link type and declared as not available to carry physical signals or channels associated with a second link type and receive a downlink signal associated with a link of the second link type, over the set of resources, excluding the subset of resources.

According to an aspect of the present disclosure, there is provided a computer readable medium storing instructions, wherein execution of the instructions, by a processor in a device, causes the processor to receive a control signal indicating a parameter related to a link of a first link type, determine, based on the parameter, a subset of resources among a set of resources in a shared resource, the subset of resources reserved for carrying physical signals or channels associated with the first link type and declared as not available to carry physical signals or channels associated with a second link type and receive a downlink signal associated with a link of the second link type, over the set of resources, excluding the subset of resources.

According to an aspect of the present disclosure, there is provided a method, for carrying out at a device. The method includes receiving a control signal indicating a parameter related to a link of a first link type, determining, based on the parameter, a subset of resources among a set of resources in a shared resource, the subset of resources reserved for carrying physical signals or channels associated with the first link type and declared as not available to carry physical signals or channels associated with a second link type and transmitting an uplink signal associated with the second link type, over the set of resources, excluding the subset of resources.

According to an aspect of the present disclosure, there is provided a device. The device includes a memory storing instructions and a processor caused, by executing the instructions, to receive a control signal indicating a parameter related to a link of a first link type, determine, based on the parameter, a subset of resources among a set of resources in a shared resource, the subset of resources reserved for carrying physical signals or channels associated with the first link type and declared as not available to carry physical signals or channels associated with a second link type and transmit an uplink signal associated with the second link type, over the set of resources, excluding the subset of resources.

According to an aspect of the present disclosure, there is provided a computer readable medium storing instructions, wherein execution of the instructions, by a processor in a device, causes the processor to receive a control signal indicating a parameter related to a link of a first link type, determine, based on the parameter, a subset of resources among a set of resources in a shared resource, the subset of resources reserved for carrying physical signals or channels associated with the first link type and declared as not available to carry physical signals or channels associated with a second link type and transmit an uplink signal associated with the second link type, over the set of resources, excluding the subset of resources.

According to an aspect of the present disclosure, there is provided a method, for carrying out at a device in a radio resource control (RRC) idle state or an RRC inactive state, of accessing a serving cell. The method including receiving system information in a broadcast signaling message from the serving cell, the system information including an indication that the serving cell is a serving cell with dynamic, shared-spectrum access through links of a first link type and links of a second link type, a first-link-type-specific random access channel configuration and a first-link-type-specific reference signal received power threshold associated with links of the first type and a second-link-type-specific random access channel configuration and a second-link-type-specific reference signal received power threshold associated with links of the second type. The method further includes detecting, in the shared downlink carrier, a reference signal for a synchronization signal block associated with a link of the first type or a link of the second link type, the reference signal having a received power, comparing the received power of the reference signal to the corresponding link-type specific threshold and responsive to a result of the comparing, carrying out an initial access procedure, using the corresponding link-type-specific random access channel configuration.

It may be shown that, by enabling link-type-specific random access to a serving cell with dynamic, shared-spectrum access through links of a first link type and links of a second link type, cell management may be simplified and access delay may be reduced.

According to an aspect of the present disclosure, there is provided a device for accessing a serving cell. The device includes a memory storing instructions and a processor. The processor is caused, by executing the instructions, to receive system information in a broadcast signaling message from the serving cell, the system information including an indication that the serving cell is a serving cell with dynamic, shared-spectrum access through links of a first link type and links of a second link type, a first-link-type-specific random access channel configuration and a first-link-type-specific reference signal received power threshold associated with links of the first type and a second-link-type-specific random access channel configuration and a second-link-type-specific reference signal received power threshold associated with links of the second type. The processor is further caused, by executing the instructions, to detect, in the shared downlink carrier, a reference signal for a synchronization signal block associated with a link of the first type or a link of the second link type, the reference signal having a received power, perform a comparison between the received power of the reference signal and the corresponding link-type specific threshold and carry out, responsive to a result of the comparison, an initial access procedure, using the corresponding link-type-specific random access channel configuration.

According to an aspect of the present disclosure, there is provided a computer readable medium storing instructions, wherein execution of the instructions, by a processor in a device for accessing a serving cell, causes the processor to receive system information in a broadcast signaling message from the serving cell, the system information including an indication that the serving cell is a serving cell with dynamic, shared-spectrum access through links of a first link type and links of a second link type, a first-link-type-specific random access channel configuration and a first-link-type-specific reference signal received power threshold associated with links of the first type and a second-link-type-specific random access channel configuration and a second-link-type-specific reference signal received power threshold associated with links of the second type. Execution of the instructions further causes the processor to detect, in the shared downlink carrier, a reference signal for a synchronization signal block associated with a link of the first type or a link of the second link type, the reference signal having a received power, perform a comparison between the received power of the reference signal and the corresponding link-type specific threshold and carry out, responsive to a result of the comparison, an initial access procedure, using the corresponding link-type-specific random access channel configuration.

According to an aspect of the present disclosure, there is provided a method, for carrying out at a device in a radio resource control (RRC) idle state or an RRC inactive state, of communicating with an serving cell. The method includes receiving, using common signaling, an indication that a cell is a shared cell, the shared cell being a serving cell providing dynamic, shared-spectrum access through links of a first link type and links of a second link type, responsive to a trigger, camping on the shared cell and initiating random access to the shared cell.

According to an aspect of the present disclosure, there is provided a device for communicating with a serving cell. The device includes a memory storing instructions and a processor. The processor is caused, by executing the instructions, to receive, using common signaling, an indication that a cell is a shared cell, the shared cell being a serving cell providing dynamic, shared-spectrum access through links of a first link type and links of a second link type, camp on the shared cell and initiate random access to the shared cell.

According to an aspect of the present disclosure, there is provided a computer readable medium storing instructions, wherein execution of the instructions, by a processor in a device for communicating with a serving cell, causes the processor to receive, using common signaling, an indication that a cell is a shared cell, the shared cell being a serving cell providing dynamic, shared-spectrum access through links of a first link type and links of a second link type, camp on the shared cell and initiate random access to the shared cell.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6 illustrates example steps in a method of accessing a serving cell, according to aspects of the present application;

FIG. 7 illustrates example steps in a method of determining configuration details for initial access on an NTN carrier, according to aspects of the present application;

FIG. 8 illustrates example steps in a method carried of determining configuration details for initial access on an NTN carrier, according to aspects of the present application;

FIG. 9 illustrates example steps in a method carried out at a UE 110, of determining configuration details for initial access on a shared carrier, according to aspects of the present application;

FIG. 10 illustrates configuration information for a multi-carrier TN/NTN cell, according to aspects of the present application;

FIG. 11 illustrates features of carrier aggregation and features of dual connectivity;

FIG. 12 illustrates a representation of uplink carriers and downlink carriers in distinct cells;

FIG. 13 illustrates a representation of UL carriers and DL carriers in a single, multi-carrier serving cell, according to aspects of the present application;

FIG. 14 illustrates a representation of a difference between cell-level mobility and beam-level mobility in a multi-carrier TN and NTN system;

FIG. 15 illustrates an option for linking or associating different component carriers belonging to a multi-carrier cell, wherein each uplink component carrier is associated with one default downlink component carrier and (at least) one non-overlapping supplementary downlink component carrier, according to aspects of the present application;

FIG. 16 illustrates an option for linking or associating different component carriers belonging to a multi-carrier cell, wherein the two downlink component carriers are partially or fully overlapped, according to aspects of the present application;

FIG. 17 illustrates an option for linking or associating different component carriers belonging to a multi-carrier cell, wherein the two downlink component carriers are aggregated into a single downlink virtual carrier and each uplink component carrier is associated with the single downlink virtual carrier, according to aspects of the present application;

FIG. 18 illustrates an option for linking or associating different component carriers belonging to a multi-carrier cell, wherein the two downlink virtual carriers are aggregated into a single downlink virtual carrier and the two uplink component carriers are aggregated into a single uplink virtual carrier, according to aspects of the present application;

FIG. 19 illustrates an option for linking or associating different component carriers belonging to a multi-carrier cell, wherein the two downlink carriers are fully overlapped and the uplink carriers are not overlapped, according to aspects of the present application;

FIG. 20 illustrates an option for linking or associating different component carriers belonging to a multi-carrier cell, wherein the two downlink carriers are partially or fully overlapped and the uplink carriers are partially or fully overlapped, according to aspects of the present application;

FIG. 21 illustrates a representation of a network made of different wireless devices such as fixed transmit receive points, drones and satellites;

FIG. 22A illustrates steps in a method of determining initial bandwidth parts for the option illustrated in FIG. 15, according to aspects of the present application;

FIG. 22B illustrates steps in a method of determining initial bandwidth parts for the option illustrated in FIG. 16, according to aspects of the present application;

FIG. 22C illustrates steps in a method of determining initial bandwidth parts for the option illustrated in FIG. 18, according to aspects of the present application;

FIG. 23 illustrates a representation of a detection of a beam failure on a bandwidth part in a terrestrial network carrier;

FIG. 24 illustrates a representation of a detection of a beam failure on a bandwidth part in a non-terrestrial network carrier;

FIG. 25A illustrates operation of a terrestrial network and a non-terrestrial network in different frequency resources of a shared carrier, according to aspects of the present application;

FIG. 25B illustrates operation of a terrestrial network and a non-terrestrial network in the same frequency resources of a shared carrier, according to aspects of the present application;

FIG. 26 illustrates example steps in a method for receiving signals in a shared carrier, according to aspects of the present application; and

FIG. 27 illustrates example steps in a method for transmitting signals in a shared carrier, according to aspects of the present application.

### DETAILED DESCRIPTION OF ILLUSTRATIVE EMBODIMENTS

For illustrative purposes, specific example embodiments will now be explained in greater detail in conjunction with the figures.

The following is a list acronyms that may be used herein, along with a reference to a term to which each acronym refers.
NR: New Radio
L1-RSRP: Layer 1 Reference Signal Receiver Power
L1-SINR: Layer 1 Signal to Interference and Noise Ratio
BFD: Beam Failure Detection
BFI: Beam Failure Instance
BFR: Beam Failure Recovery
BLER: Block Error Rate
BPL: Beam Pair Link
TRP: Transmit-Receive Point
T-TRP: Terrestrial TRP
NT-TRP: Non-Terrestrial TRP
FDD: Frequency Division Duplexing
TDD: Time Division Duplexing
MCG: Master Cell Group
UAV: Unmanned Aerial Vehicle/drone
RNTI: Radio Network Temporary Identifier
C-RNTI: Cell RNTI
HARQ: Hybrid Automatic Repeat Request
TB: Transport Block
BWP: Bandwidth part

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

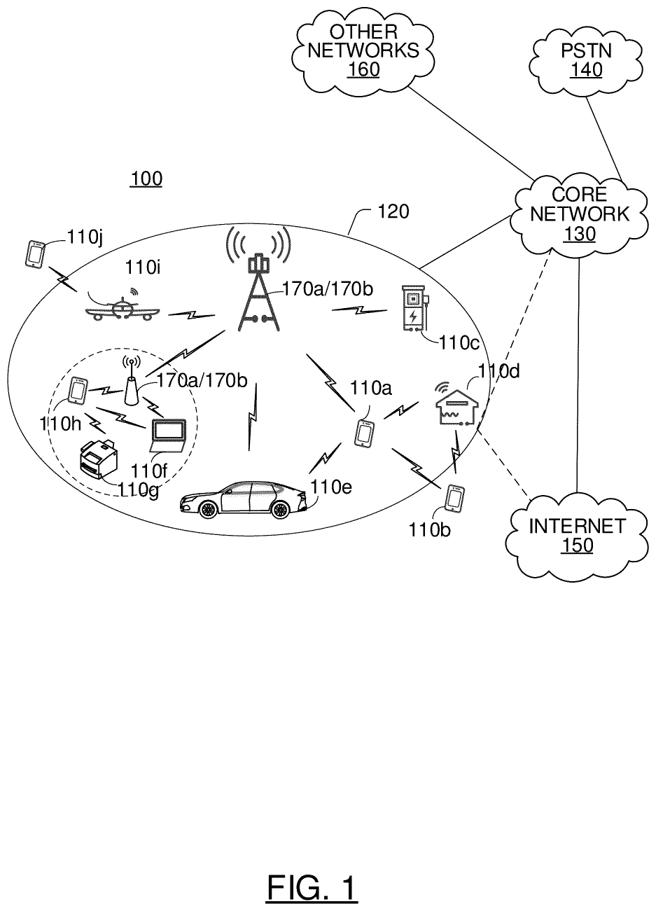

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

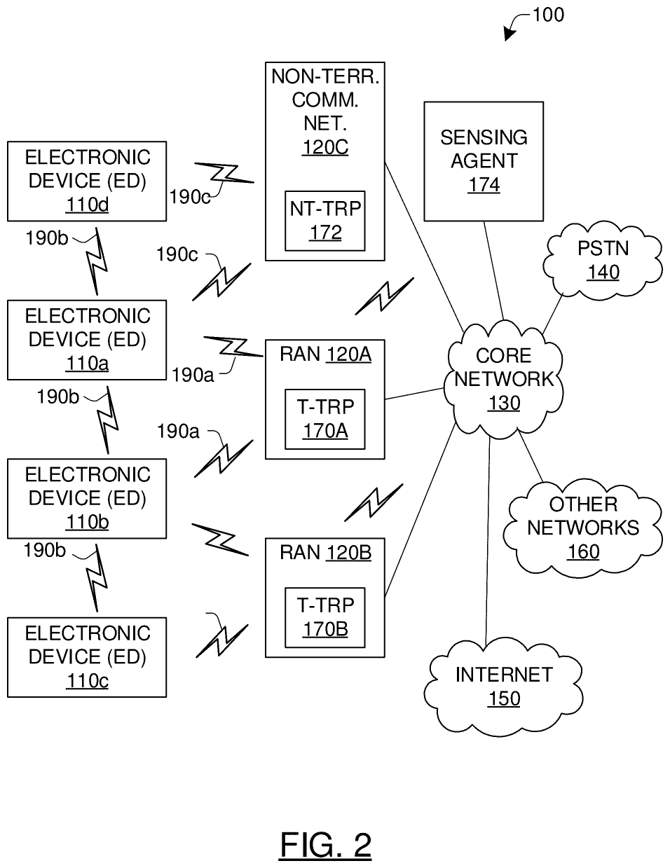

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink (UL) and/or downlink (DL) transmission over a terrestrial air interface 190a with T-TRP 170a. In some examples, the EDs 110a, 110b, 110c and nod may also communicate directly with one another via one or more sidelink air interfaces 190b. In some examples, the ED nod may communicate an uplink and/or downlink transmission over an non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

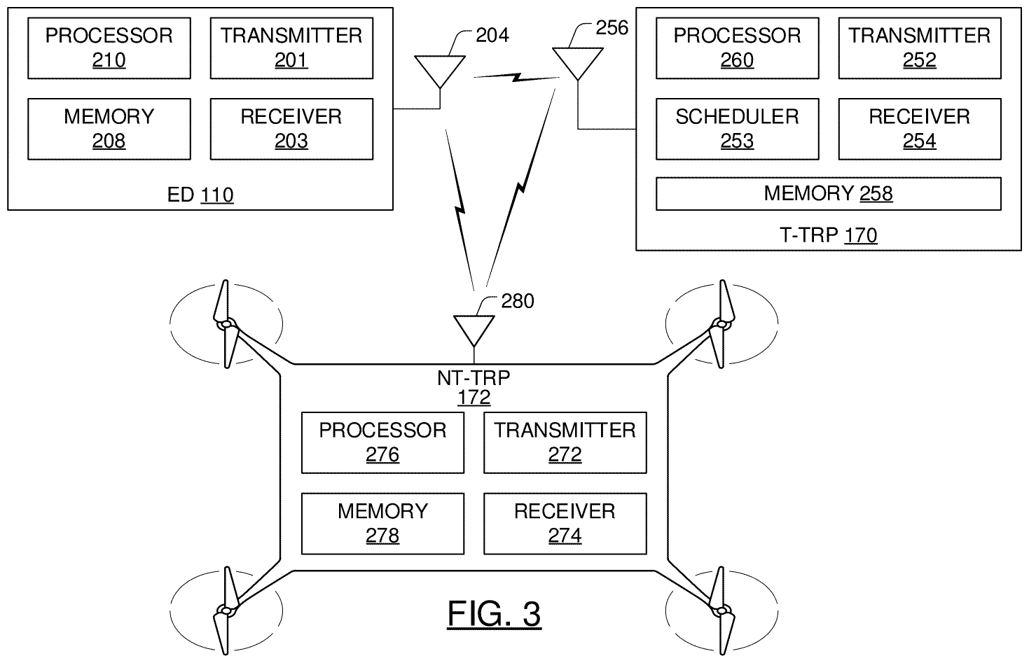

FIG. 3 illustrates another example of an ED no and a base station 170a, 170b and/or 170c. The ED no is used to connect persons, objects, machines, etc. The ED no may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED no represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

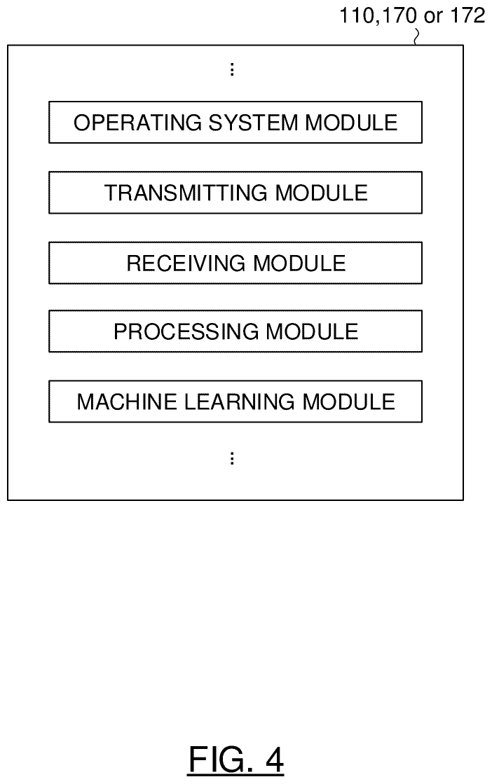

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all” concept. For example, it may be that the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support frequencies below known 6 GHz bands and frequencies beyond the 6 GHz bands (e.g., mmWave bands) for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain and a frequency domain self-contained design may support more flexible RAN slicing through channel resource sharing between different services in both frequency and time.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occurs on the same time-frequency resource, i.e., a device can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which slots is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the known new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing, the slot length is 1 ms and, for 30 kHz subcarrier spacing, the slot length is 0.5 ms. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing (SCS); flexible transmission duration of basic transmission unit; and flexible switch gap.

The frame length need not be limited to 10 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set to 5 ms for autonomous vehicle applications. As another example, smart meters on houses may not require fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs 110 or a group of UEs 110. For this case, the slot configuration information may be transmitted to the UEs 110 in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler shift and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler); and/or a latency requirement; and/or an available time duration. As another example, a symbol block length may be adjusted to fit an available time duration in the frame.

A frame may include both a downlink portion, for downlink transmissions from a base station 170, and an uplink portion, for uplink transmissions from the UEs 110. A gap may be present between each uplink and downlink portion, which gap is referred to as a switching gap. The switching gap length (duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A device, such as a base station 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency, the lowest frequency or the highest frequency of the carrier. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage, β/2, of the total mean transmitted power, for example, the value of β/2 is taken as 0-5%.

The carrier, the BWP or the occupied bandwidth may be signaled by a network device (e.g., by a base station 170) dynamically, e.g., in physical layer control signaling such as the known downlink control channel (DCI), or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

UE position information is often used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system can be separate from the communication system, it could be advantageous to gather the information using a multi-carrier system, which reduces the hardware (and cost) in the system as well as the time, frequency or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANs 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

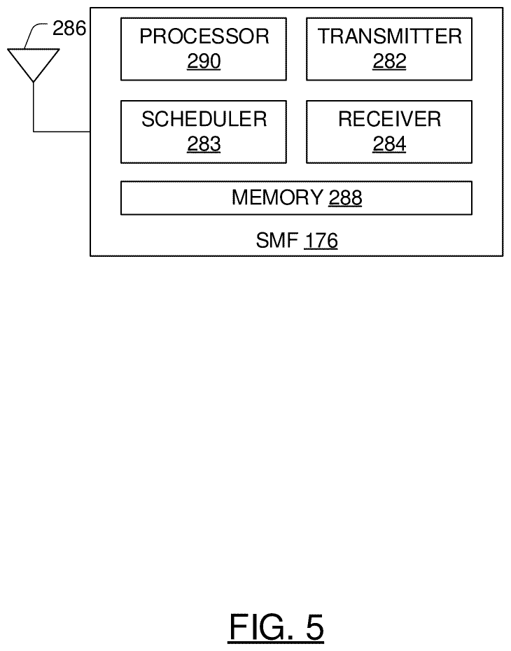

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in process of determining the pose of the enquirer. The enquirer may transmit or receive (or both) a signal specific to pose determination process. Positioning techniques based on a global navigation satellite system (GNSS) such as the known Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C may be defined for data communication, while a second physical downlink shared channel PDSCH-S may be defined for sensing. Similarly, separate physical uplink shared channels (PUSCHs), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectrum efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectrum efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A panel is a unit of an antenna group, or antenna array, or antenna sub-array, which unit can control a Tx beam or a Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or a SSB resource identifier, or a sounding reference signal (SRS) resource identifier, or other reference signal resource identifier.

A user equipment (UE) in a multi-carrier TN and NTN system may be configured for Dual Connectivity (DC), wherein the UE may be simultaneously connected to two serving nodes. The two serving nodes may be referenced as a “master node” (MN) and a “secondary node” (SN).

In a first example case, the two serving nodes may employ the same radio access technology (e.g., LTE or NR).

In a second example case, the two serving nodes may employ different radio access technologies (RATs). The second example case is contemplated as LTE-NR DC or multi-RAT DC (MRDC). In the second example case, DC and CA may be used in conjunction with one another, in which case a given UE may be connected to two serving nodes and may be configured with multiple cells in each of the radio access technologies. The given UE may connect to a master cell group (MCG) and to a secondary cell group (SCG).

Current solutions for beam management procedures in cellular systems are based on beam sweeping for Initial Access, physical layer beam reference signal received power (RSRP) measurements (e.g., L1-RSRP) and signal-to-interference-and-noise ratio (SINR) measurements (e.g., L1-SINR), beam failure detection and beam failure recovery. All these procedures are referred to as “mobility within a cell” and thus don't extend beyond the coverage area corresponding to a cell.

Beam Failure Detection (BFD) procedure in cellular systems is based on monitoring, at the UE, the quality of the link of the serving cell. The UE may be configured to detect and measure BFD reference signals (BFD-RS). Based on detecting and measuring BFD-RS, the UE may compare the quality of the BFD-RS to a hypothetical PDCCH Block Error Rate (BLER). If the quality of the measurement on the BFD-RS is below the hypothetical PDCCH BLER, then a Beam Failure Instance (BFI) is considered to have taken place. A “beam failure” is considered to have been detected when several consecutive BFIs have occurred.

A Beam Failure Recovery (BFR) procedure in cellular systems may be shown to involve initiating, by a given UE, a search for a new serving beam responsive to detecting a beam failure on the serving beam. The given UE may be configured with so-called “candidate beams.” The given UE may attempt to detect and measure the candidate beams. The given UE searches for a “best” beam among candidate beams. If the quality of the best beam is above a predetermined threshold, the UE may initiate a Random Access step to complete the BFR procedure.

Aspects of the present application relate to shared/multi-carrier integrated cells in so-called integrated terrestrial and non-terrestrial networks, such networks include both terrestrial serving nodes (gNBs) and non-terrestrial serving nodes (gNBs) in addition to terrestrial TRPs 172 and non-terrestrial TRPs 172.

Aspects of the present application relate to integrating terrestrial and non-terrestrial networks into a single radio communication system/network. Further aspects of the present application relate to solving issues related to the integration of TN and NTN.

DC/CA are not currently known to provide a suitable framework for a multi-carrier TN/NTN solution. Different carriers in DC/CA correspond to different cells. The different cell correspondence may be shown to introduce drawbacks, such as unnecessary handovers, carrier activation latency, carrier deactivation latency, etc.

In addition, the CA mechanism may be shown to only benefit UEs in the RRC Connected state, i.e., UEs that have completed RRC connection with the network. That is, the CA mechanism may be shown to fail to benefit UEs in an Idle state and UEs in an Inactive state (e.g., UE that have yet to perform an initial access).

In the context of a multi-carrier Terrestrial and Non-Terrestrial system, aggregating the throughput of multiple carriers may be shown to be more useful for DL than it is for UL. A consequence of the large distance between satellites and UEs on the ground is a relatively large propagation delay. Accordingly, it is typical that goals for UL are related to optimizing coverage, saving UE power consumption and reducing UE complexity. It may be shown, then, that allowing flexibility between UL Carrier Aggregation (CA) and supplementary UL operation would be beneficial. It may be beneficial to decouple a given UL carrier from a related DL carrier and to make allowances for a flexible linkage between the given UL carrier and the related DL carrier.

Aspects of Beam Management procedures in 5G NR may be considered to be inherently time-consuming. Typically, Beam Management functions, such as BFD and BFR, are restricted to the serving cell. The serving cell may be a terrestrial serving cell or a non-terrestrial serving cell. Even with Beam Management functions restricted to the serving cell, the amount of time taken for UEs to find a usable candidate beam may be significant. Such a significant time may be shown to result in a data session getting dropped in a time-sensitive scenario.

The current Beam Management procedures in 5G NR, may be considered to be restricted scope and, consequently, limited in efficiency. Since Beam Management procedures are limited to the serving cell, candidate beams are also limited to the serving cell. It follows that a given UE will not consider a beam from a neighbor TRPs or even a beam from a non-terrestrial TRP. If no suitable candidate beam is found and the serving cell is a terrestrial serving cell, the given UE may default to randomly selecting a beam from among the terrestrial beams available from the serving cell. If no suitable candidate beam is found and the serving cell is a non-terrestrial serving cell, the given UE may default to randomly selecting a beam from among the non-terrestrial beams available from the serving cell.

Beam Management procedures in 5G NR may be considered to be reactive in nature. At the time of the failure of a last serving beam pair link between a UE and a serving cell, it may be considered that it is already too late for the UE to recover. Accordingly, the UE has to spend time finding a suitable candidate beam. Moreover, the former serving cell cannot assist the UE in the Beam Management procedures due to the last of the beam pair links between the UE and the former serving cell having failed.

In NR, synchronization signals/PBCH blocks (SSBs) are cell-specific, in the sense that the SSBs carry the physical layer cell ID (PCID) of the cell. The SSBs are organized in burst sets. The burst sets are transmitted periodically. Different SSBs are beamformed, i.e., transmitted in different spatial directions, spanning the coverage area of the cell. Each SSB occupies 240 subcarriers in the frequency domain and four symbols in the time domain. Each SSB contains primary synchronization signals (PSS) and secondary synchronization signals (SSS) and a physical broadcast channel (PBCH). PSS and SSS, together, carry the physical cell identity (PCID) and the PBCH carries the Master Information Block (MIB) and some other payload bits. Within the frequency span of a given carrier, multiple SSBs in different frequency locations can be transmitted. The multiple SSBs do not need to carry the same PCID. However, a cell-defining SSB (CD-SSB) has a unique location within the carrier. This unique location intersects with a SSB synchronization raster that is defined for the frequency band of the cell. The CD-SSB carries the unique PCID of the cell. The CD-SSB has an associated Remaining Minimum System Information (RMSI). That is, the CD-SSB indicates a time-frequency location of a control resource set (CORESET #0). The UE is expected to monitor the control resource set to detect and decode a PDCCH/PDSCH carrying the RMSI. Those SSBs that are not CD-SSBs are known to indicate a frequency location for the CD-SSB on the same carrier.

A given UE may be configured with multiple RSs for BFD on different carriers.

Beam failure may be considered to have been detected when a measured quality, q₀, of the beams in a given BWP, measured through a corresponding BFD RS, drops below a predetermined threshold, Q_{out,LR}. Responsive to the measured quality, q₀, dropping below Q_{out,LR}, the UE continues to monitor/measure the quality, q₀, of the current beams. The UE may also begin to monitor/measure the quality, q₁, of new candidate beams.

Responsive to the meeting of predetermined conditions, the UE may switch from a current beam to a new beam. The switching may be accomplished through an associated physical random access channel (PRACH) resource configuration.

When Beam Failure is detected by the UE in a given BWP of a given carrier of a multi-carrier cell, the UE may consider a list of candidate beams belonging to a corresponding BWP and select a beam with an RS whose L1-RSRP measurement is above a predetermined threshold, Q_{in,LR}, which may also be referred to as “rsrp-ThresholdSSB.”

After the UE has found a suitable RS, the UE performs Contention-Free/Contention-based random access channel (RACH) in order to indicate the selected RS to the NW and waits for the RACH response on the search space indicated by recoverySearchSpaceId.

If RACH response is received before a duration, defined as ra-ResponseWindow, has expired, BFR is considered successful

Aspects of the present application relate to a multi-carrier serving cell configured to enable a flexible, multi-connectivity framework among TN carriers and NTN carriers. Within the multi-carrier serving cell, UL carriers and DL carriers in paired frequency division duplex (FDD) spectrum or unpaired time division duplex (TDD) spectrum may be decoupled from each other. Multiple DL carriers may be configured within a single cell (e.g., within a single, multi-carrier cell) and each UL carrier may be associated with, or linked to, multiple DL carriers.

The multi-carrier serving cell can be associated with multiple contiguous/non-contiguous DL carriers. The multiple carriers may be intra-band contiguous carriers. The multiple carriers may be intra-band non-contiguous carriers. The multiple carriers may be inter-band carriers. The multiple carriers may be a mix of intra-band contiguous/non-contiguous carriers and inter-band carriers.

The multi-carrier serving cell may be implemented using a single, shared carrier between the TN and the NTN.

Conveniently, a given UE in the idle state or the inactive state may connect to the multi-carrier serving cell via a TN carrier, via an NTN carrier or via a shared TN/NTN carrier.

Once a UE has connected to the multi-carrier serving cell, the UE may have access to all the carrier types, without carrying out such procedures as small cell addition procedures, releasing procedures, activation procedures, (mobility) measurement procedures, etc. Besides, layer-1/2 beam-level mobility procedures may be used to control UE mobility within the multi-carrier serving cell. The layer-1/2 beam-level mobility procedures include signaling procedures and measurement procedures. The layer-1/2 beam-level mobility procedures stand in contrast to layer-3 signaling procedures and measurement filtering procedures known to be used for layer-3 handover.

For a multi-carrier serving cell, each UL carrier may be associated with, or linked to, more than one physical DL carrier. That is, a UL TN carrier may be linked to a DL TN carrier and a DL NTN carrier. The linking between the carrier frequencies of the downlink resources from the shared DL carrier or multiple DL carriers of the multi-carrier serving cell and the carrier frequencies of the uplink resources of the shared UL carrier or multiple UL carriers of the multi-carrier serving cell may be indicated in system information transmitted on the downlink resources of each DL carrier or one of the DL carriers of the multi-carrier serving cell.

Component carriers belonging to a multi-carrier serving cell may be TDD (unpaired carrier) or FDD (paired carrier). It may be considered that there are different options on how the different component carriers belonging to a multi-carrier serving cell are linked or associated.

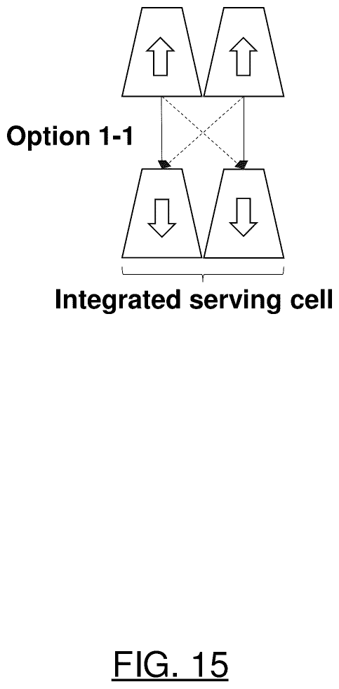

Option 1-1 (see FIG. 15): Each UL component carrier (CC) is associated with one default DL CC and (at least) one non-overlapping supplementary DL CC.

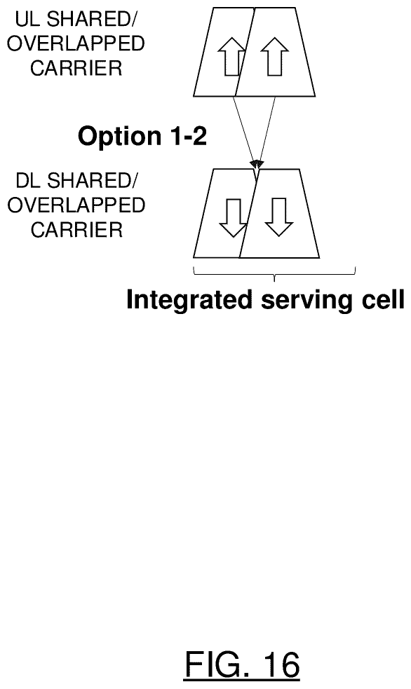

Option 1-2 (shared DL carrier, see FIG. 16): Two DL CCs are partially or fully overlapped. In this option, it is possible that the DL carrier is fully overlapped and the UL carriers are not overlapped at all.

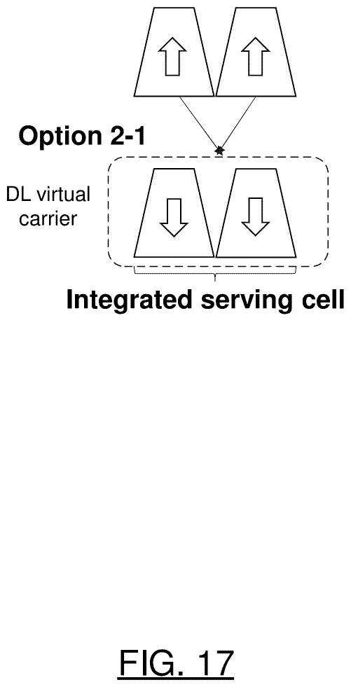

Option 2-1 (see FIG. 17): Two DL CCs are aggregated into a single DL virtual carrier (VC) and each UL CC is associated with the single DL VC. For example, a TN UL carrier and an NTN UL carrier may share the same DL virtual carrier.

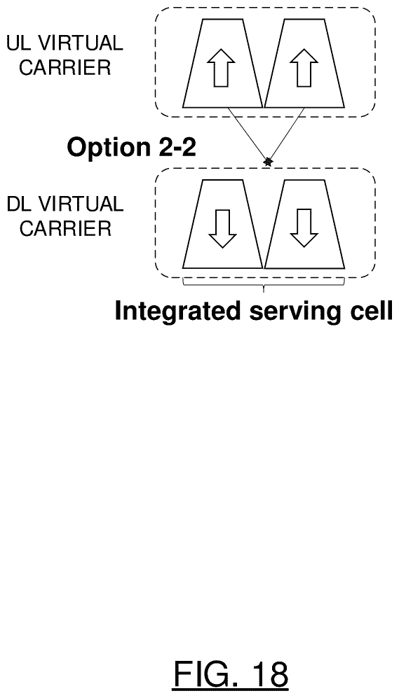

Option 2-2 (see FIG. 18): Two DL CCs are aggregated into a single DL VC and two UL CCs are aggregated into a single UL VC.

In the following, a network may include many distinct wireless devices, such as UEs, fixed TRPs, or moving TRPs or UEs onboard drones, HAPSs and or satellites.

Notably, the UEs may be configured to make measurements during measurement intervals. In each measurement interval within a BWP corresponding to one DL carrier, the UE may detect and measure reference signals corresponding to one beam pair link and may be configured to detect up to one BFI per measurement interval and per beam pair link.

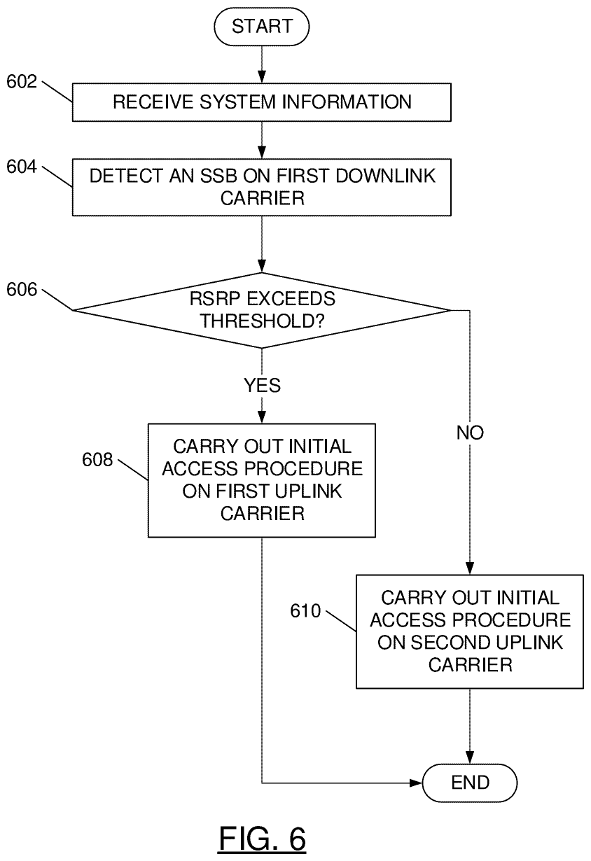

Aspects of the present application relate to initial access procedures and random access procedures for UEs in the RRC Idle state or the RRC Inactive state as such UEs attempt to establish a connection in a multi-carrier serving cell. Example steps in a method of accessing a serving cell are illustrated in FIG. 6.

A given UE that is in RRC Idle state or RRC Inactive state may be informed that a serving cell is a multi-carrier TN/NTN serving cell upon receiving (step 602) a broadcast signaling message that employs common signaling. The broadcast signaling message may include a MIB, as part of a synchronization signal/PBCH block (SSB). The broadcast signaling message may include a system information block 1 (SIB1) as part of a RMSI. The received (step 602) broadcast signaling message may include so-called “system information.” The system information may include an indication that the serving cell is a multi-carrier TN/NTN serving cell including at least one TN carrier and at least one NTN carrier.

The given UE may decide to camp on a multi-carrier serving cell before initiating an initial access procedure to the multi-carrier serving cell responsive to receiving a DL paging message. Alternatively, the given UE may decide to camp on a multi-carrier serving cell before initiating an initial access procedure to the multi-carrier serving cell in a situation wherein the given UE has UL data to transmit.

It may be that the given UE is in the RRC Idle state or the RRC Inactive state and has, at the completion of a cell selection/reselection process, camped on the multi-carrier cell. The given UE may then monitor for system information and (in most cases) paging information from the multi-carrier serving cell. Note that services may be limited and that a public land mobile network may not be aware of the existence of the given UE within the multi-carrier serving cell.

Each CC of the multi-carrier serving cell may have several SSBs allocated in different frequency locations or bandwidth parts, with one or more of the several SSBs being cell-defining SSBs (CD-SSBs). For a multi-carrier serving cell, CD-SSBs may be transmitted only on TN carriers, transmitted only on NTN carriers or transmitted on both TN carriers and NTN carriers. The frequency locations of the CD-SSBs within the multi-carrier serving cell may be cross-carrier indicated. That is, a non-cell-defining SSB in one carrier (e.g., a TN carrier) may indicate the location of a CD-SSB in another carrier (e.g., an NTN carrier).

The multi-carrier TN/NTN cell system information received (step 602) via MIB or SIB1 (e.g., in an RMSI) may provide, to the given UE, a separate RACH configuration for each different carrier or carrier type. For example, a first RACH configuration may be provided for carriers of the TN type and a second RACH configuration may be provided for carriers of the NTN type. The multi-carrier TN/NTN cell system information may also provide an indication that the multi-carrier serving cell operates in a UL carrier aggregation mode or a supplementary UL mode.

In some embodiments, the UE may indicate to the network the support for access to, or operation within, a multi-carrier serving cell or communicating control and data with the multi-carrier serving cell for the given band combination as a UE capability. The network may use such report to configure the UE with parameters specific to the multi-carrier serving cell operation. Such parameters may for example include whether the serving cell operates in a UL carrier aggregation mode or a supplementary uplink mode, cross-carrier BWP or cross-carrier transmission/reception beam configuration.

If the cell is a multi-carrier TN/NTN cell with a given band combination and the UE supports operation in a multi-carrier TN/NTN cell for the given band combination, the UE may carry out initial access, on either the TN UL carrier (step 608) or the NTN UL carrier (step 610), using the first RACH configuration for carriers of the TN type.

Consider a multi-carrier TN/NTN serving cell, with a given band combination, operating in UL carrier aggregation mode and a UE that supports operation in a multi-carrier TN/NTN serving cell for the given band combination. The UE may detect (step 604) an SSB in the TN DL carrier. The UE may treat the SSB as a reference signal. Indeed, in addition to PSS and SSS, the SSB includes a PBCH channel and an accompanying demodulation reference signal (DMRS). The DMRS may be used as a reference signal on which to carry out RSRP measurements when detecting the SSB. Responsive to the UE determining (step 606) that the RSRP associated with the SSB in the TN DL carrier exceeds the TN-carrier-specific threshold received (step 602) in the system information, the UE may carry out (step 608) initial access on the TN UL carrier using the first RACH configuration for carriers of the TN type. Responsive to the UE determining (step 606) the SSB in the TN DL carrier fails to exceed the TN-carrier-specific threshold, the UE may carry out (step 610) initial access on the NTN UL carrier using the second RACH configuration for carriers of the NTN type.

If the serving cell is a multi-carrier TN/NTN serving cell, with a given band combination, operating in a supplementary UL mode and the UE supports operation in a multi-carrier TN/NTN serving cell for the given band combination, the UE may determine a carrier to use for carrying out initial access by comparing a measured RSRP of a detected SSB against a carrier-selection threshold. The carrier-selection threshold may be provided as part of the multi-carrier serving cell system information. As discussed hereinbefore, the multi-carrier serving cell system information may be received (step 602) via common signaling (e.g., MIB/SIB1). The threshold may be common across DL carriers or dependent on the DL carrier on which the SSB has been detected. That is, there may be a distinct threshold set for each type of carrier. That is, there may be a threshold, Th_{TN}, for carriers of the TN type and another threshold, Th_{NTN}, for carriers of the NTN type.

Upon determining (step 606) that the measured RSRP of a detected TN SSB, SSB_{TN}, fails to exceed the threshold, Th_{TN}, for carriers of the TN type, the UE may select an NTN UL carrier for carrying out (step 610) initial access. Upon determining (step 606) that the measured RSRP of a detected TN SSB, SSB_{TN}, exceeds the threshold, Th_{TN}, for carriers of the TN type, the UE may select a TN UL carrier for carrying out (step 608) initial access.

The foregoing scenario may be switched so that the detected SSB is on a carrier of the NTN type. Upon determining (step 606) that the measured RSRP of a detected NTN SSB, SSB_{NTN}, fails to exceed the threshold, Th_{NTN}, for carriers of the NTN type, the UE may select a TN carrier for carrying out (step 610) initial access. Upon determining that the measured RSRP of a detected NTN SSB, SSB_{NTN}, exceeds the threshold, Th_{NTN}, for carriers of the NTN type, the UE may select an NTN carrier for carrying out (step 608) initial access.

In case of a DL shared carrier, the threshold may be defined as a common threshold, Th_{Common}. Upon determining (step 606) that the measured RSRP of a detected SSB is lower than the common threshold, Th_{Common}, the UE may select a TN carrier for carrying out (step 610) initial access. Upon determining that the measured RSRP of a detected SSB exceeds the common threshold, Th_{Common}, the UE may select an NTN carrier for carrying out (step 608) initial access, provided the measured RSRP is above another carrier-specific threshold for carrying out initial access on the carrier.

Carrying out (step 608 or 610) initial access may involve transmitting a random access preamble (Message 1) or Message 3 on the selected UL carrier.

For UE in the RRC Connected state, the UL carrier to select for carrying out initial access may be explicitly configured to the UE via Layer 3 RRC signaling.

Aspects of the present application relate to enabling a carrier-specific initial BWP after initial access to the multi-carrier cell.

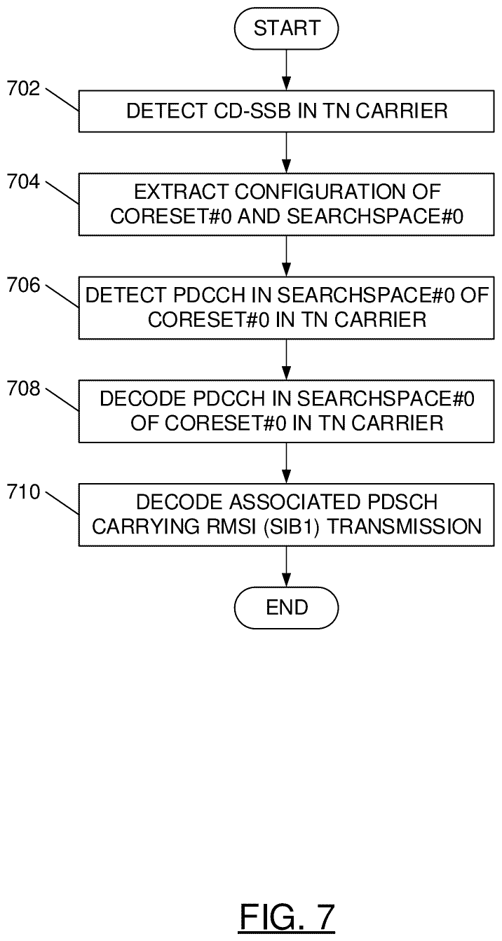

For option 1-1 (two physical DL carriers), CD-SSBs are transmitted in one or more DL carriers. FIG. 7 illustrates example steps in a method carried out at a UE 110, of determining configuration details for initial access. Upon detecting (step 702) a CD-SSB in one of the TN DL carriers, the UE may extract (step 704) the configuration of CORSET #0 and the associated search space zero for its own carrier or for a specific beam of the TN DL carrier. Upon detecting (step 706) the PDCCH in search space zero of CORSET #0, the UE 110 may decode (step 708) the PDCCH and decode (step 710) the associated PDSCH carrying the RMSI (SIB1) transmission. The RMSI may be expected to contain configuration details such as an indication of the initial DL BWP and the initial UL BWP for the TN carrier. The RMSI may also be expected to contain configuration details such as an indication of the initial DL BWPs and the initial UL BWPs of one or more of the beams of the NTN carrier.

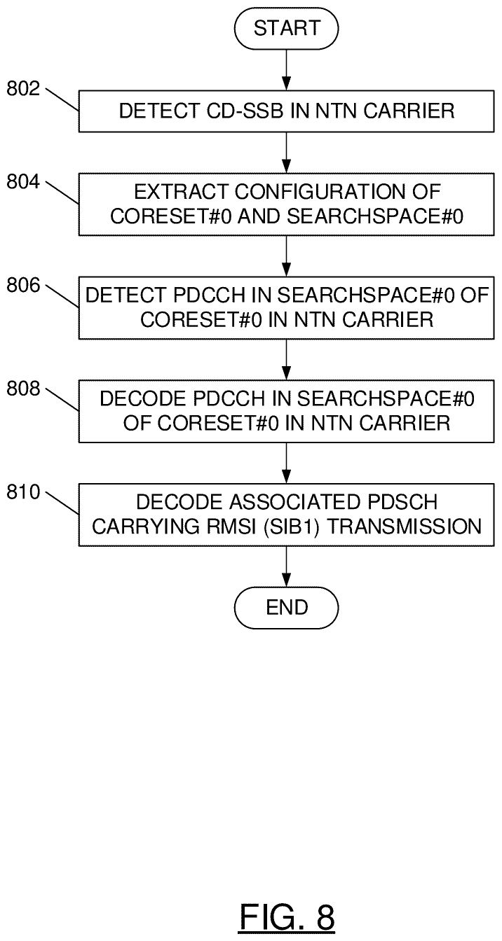

FIG. 8 illustrates example steps in a method carried out at a UE 110, of determining configuration details for initial access. Upon detecting (step 802) a CD-SSB in one of the NTN DL carriers, the UE may extract (step 804) the configuration of CORSET #0 and the associated search space zero for its own carrier or for a specific beam of the NTN DL carrier. Upon detecting (step 806) the PDCCH in search space zero of CORSET #0, the UE 110 may decode (step 808) the PDCCH and decode (step 810) the associated PDSCH carrying the RMSI (SIB1) transmission. The RMSI may be expected to contain configuration details such as an indication of the initial DL BWP and the initial UL BWP for the NTN carrier or a specific NTN beam. The RMSI may also be expected to contain configuration details such as an indication of the initial DL BWPs and the initial UL BWPs of one or more of the beams of the NTN carrier. The RMSI may be further expected to contain configuration details such as an indication of the initial DL BWP and the initial UL BWP for the TN carrier.

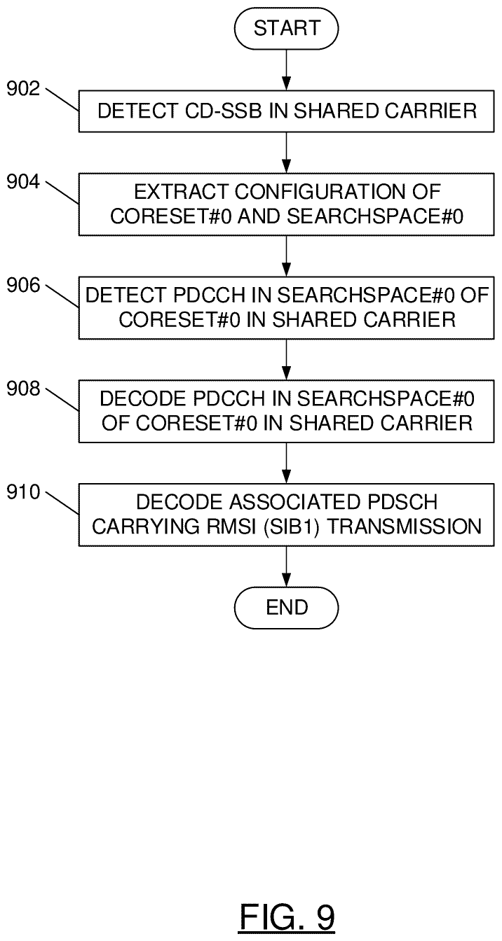

For option 1-2 (shared carrier), one CD-SSBs is transmitted on the shared DL carrier. FIG. 9 illustrates example steps in a method carried out at a UE 110, of determining configuration details for initial access on a shared carrier. Upon detecting (step 902) a CD-SSB in the shared carrier, the UE may extract (step 904) the configuration of CORSET #0 and the associated search space zero for the shared carrier or a specific beam of the shared carrier. Upon detecting (step 906) the PDCCH in search space zero of CORSET #0, the UE 110 may decode (step 908) the PDCCH and decode (step 910) the associated PDSCH carrying the RMSI (SIB1) transmission. The RMSI may be expected to contain configuration details such as an indication of the initial TN DL BWP and the initial TN UL BWP for the shared carrier. The RMSI may also be expected to contain configuration details such as an indication of the initial NTN DL BWPs and the initial NTN UL BWPs for one or more of the NTN beams of the shared carrier.

Aspects of the present application relate to transmitting PUCCH and transmitting PUSCH in a manner consistent with the various options presented hereinbefore.

Consider a cell that is a multi-carrier TN/NTN cell operating in a supplementary UL mode with a given band combination and a UE 110 that supports operation in a multi-carrier TN/NTN cell for the given band combination.

The UE 110 may be configured for PUCCH transmitting by means of RRC signaling or indicated via MAC control element (CE) which UL carrier to use for transmitting PUCCH. The configuring may indicate, to the UE 110, a UL CC on which to transmit the PUCCH. Transmitting the PUCCH may be understood to include transmitting ACK/NACK feedback. The ACK/NACK feedback may be joint ACK/NACK feedback or separate ACK/NACK feedback. Separate ACK/NACK feedback may, for example, correspond to separate DL carriers.

The UE 110 may be configured for PUSCH transmitting by means of RRC signaling. In one instance, the configuring may instruct the UE 110 to transmit the PUSCH on the same UL CC as the UE 110 uses to transmit the PUCCH. In another instance, the configuring may instruct the UE 110 to dynamically select a UL CC on which to transmit the PUSCH.

In contrast to RRC signaling, the UE 110 may be configured for PUSCH transmitting by means of a UL grant, received by the UE 110 over the PDCCH. The UL grant may include an indication of a UL CC to be used, by the UE 110, for the scheduled PUSCH.

The UE 110 may be configured to recognize that the UE 110 is to transmit Uplink Control Information (UCI) on the PUCCH using a UL CC (e.g., a TN carrier or an NTN carrier) during a time interval that overlaps with a scheduled PUSCH transmission on the UL CC. Responsive to such recognizing, the UE 110 may multiplex the UCI onto the PUSCH.

Aspects of the present application relate to Carrier Type/BWP Operation using the multi-carrier cell.

Within the multi-carrier serving cell, the UE 110 may be configured with multiple UL/DL bandwidth parts (BWPs) belonging to the different carrier types, including TN carriers and NTN carriers. In one example, the UE 110 may be configured with at least one active TN DL BWP and at least one active NTN DL BWP. The UE 110 may be configured to dynamically switch from one active TN BWP to an active NTN BWP and vice versa. “Carrier type” may be established as one parameter in a BWP configuration. “Carrier type” may be associated with a certain BWP configuration.

If the carrier type is NTN, some BWP parameters may be arranged to take on default values. If the carrier type is NTN, some BWP parameters may include parameters (e.g., timing offset) that are different than those parameters that are included when the carrier type is TN. For the NTN carrier type, the UE 110 may be configured with one beam-specific BWP or a plurality of beam-specific BWPs. A beam-specific BWP may be understood to be a BWP that is associated with a specific beam direction.

The specific beam direction may be a receive beam direction associated with a particular DL or UL RS, Transmission Configuration Indicator (TCI) state, or Quasi-colocation (QCL)ed with a particular DL or UL RS. The specific beam direction may be a transmit beam direction or a transmit beam angle. The transmit beam direction may be specified in terms of a direction for a peak of the transmit beam. The direction may be expressed in terms of an elevation angle and an azimuth angle. The transmit beam direction may be specified in terms of a half-power beamwidth (HPBW). The transmit beam direction may be specified in terms of a polarization, including Right Hand Circular Polarized (RHCP) and Left Hand Circular Polarized (LHCP).

Consider a cell that is a multi-carrier TN/NTN cell with a given band combination and a UE 110 that supports operation in a multi-carrier TN/NTN cell for the given band combination. Within the multi-carrier TN/NTN cell, the UE 110 may be configured with a UE-specific DL BWP for receiving data on the TN carrier and UE-specific UL BWP for transmitting data on the TN carrier. The UE 110 may also be configured with a beam-specific BWP for transmitting/receiving data on the NTN carrier simultaneously with the transmission/reception of data on the TN carrier.

The UE 110, when communicating with the multi-carrier cell in UL (e.g., over a PUSCH) and/or DL (e.g., over a PDSCH), may use some resources from a BWP of a carrier of a first type and some resources from a BWP of a carrier of the second type. The resources may be time resources or frequency resources or code resources or space/antenna port resources. Additionally, the resources may overlap in time and/or overlap in frequency or space. One of the BWPs may be a beam-specific BWP.

A PDSCH may be dynamically cross-carrier scheduled. That is, the UE 110 may receive a PDCCH in a DL carrier of one carrier type and the PDCCH may schedule a PDSCH in a DL carrier of another carrier type. The PDCCH may include a field containing an indication of a carrier type. For one example, a field of two bits may be used to indicate a carrier type. A first two-bit value may map to an indication of the TN carrier type. A second two-bit value may map to an indication of the NTN carrier type. A third two-bit value may map to an indication of the shared carrier type. The mapping of the remaining two-bit value may be reserved. For another example, a field of a single bit may be used to indicate a carrier type. A first one-bit value may map to an indication of the TN carrier type. A second one-bit value may map to an indication of the NTN carrier type. In addition to the carrier type, the cross-carrier scheduling DCI may indicate a carrier or BWP-type specific timing offset to be used by the UE to receive the scheduled PDSCH or transmit the scheduled PUSCH and would apply on top of the regular timing information provided by the time-domain resource allocation (TDRA) field in the DCI. For example, the carrier-specific timing offset may be a time duration value, K, expressed in terms of a time unit, such as milliseconds or in terms of an integer number of time slots in the numerology of the BWP. For instance, K can be 0 for TN carrier/BWP and K can be non-zero for NTN carrier-BWP. The scheduling DCI may indicate an index that maps to a value of K among a set of pre-configured values of K. The scheduled PDSCH would be received at time slot n+timing information indicated in TDRA+K.

The UE 110 may also receive a dynamic indication that acts to enable a particular carrier or a particular BWP for transmission and/or reception of data. The dynamic indication, via DCI in PDCCH or MAC CE in PDSCH, may specify an UL carrier of a particular carrier type. The dynamic indication may specify a DL carrier of a particular carrier type. The dynamic indication may specify a BWP on a carrier of a particular carrier type. The dynamic indication may, alternatively, disable a carrier of a particular type. One benefit of disabling a carrier of a particular type may be energy savings. The dynamic indication may be implemented in downlink control information carried by PDCCH or MAC CE in PDSCH. In particular, the indication may be a one bit field or a two bit field.

Within the multi-carrier cell, the UE 110 may be configured with multiple UL BWPs and multiple DL BWPs belonging to the different carrier types (e.g., the TN carrier type and the NTN carrier type). The UE 110 may then be configured with at least one active TN DL BWP and one active NTN DL BWP. The UE 110 may dynamically switch from the active TN DL BWP to the active NTN DL BWP and vice versa.

A dedicated, UE-specific BWP or a beam-specific BWP may be indicated to a UE served by a drone (UAV) TRP. The BWP may belong to a physical carrier (e.g., a TN carrier or an NTN carrier) or may belong to a virtual carrier.

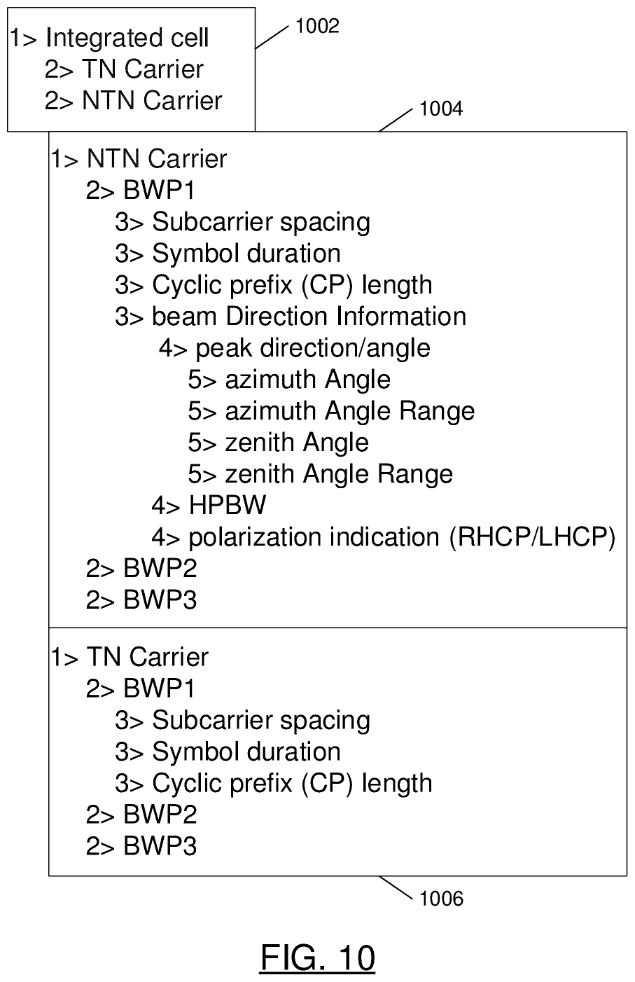

FIG. 10 illustrates configuration information 1002 for a multi-carrier TN/NTN cell. Included in configuration information 1002 for the multi-carrier TN/NTN cell is configuration information 1004 for an NTN carrier and configuration information 1006 for a TN carrier. The configuration information 1004 for the NTN carrier is illustrated, in FIG. 10, as including configuration information for three BWPs: NTN BWP1; NTN BWP2; and NTN BWP3. The configuration information for the NTN BWP1 includes: subcarrier spacing; symbol duration; cyclic prefix (CP) length; and beam direction information. The beam direction information includes: peak direction/angle information; HPBW information; and a polarization indication (RHCP/LHCP). The peak direction/angle information includes: azimuth Angle; azimuth Angle Range; zenith Angle; and zenith Angle Range.

The configuration information 1006 for the TN carrier is illustrated, in FIG. 10, as including configuration information for three BWPs: TN BWP1; TN BWP2; and TN BWP3. The configuration information for the TN BWP1 includes: subcarrier spacing; symbol duration; and cyclic prefix (CP) length.

Aspects of the present application relate to BFR using the multi-carrier cell.

It may be shown that a multi-carrier TN/NTN cell allows for a UE to recover quickly after experiencing a radio link (RL) failure or after detecting a beam failure (BF).

Consider that a UE 110 has detected a BF on a BWP of a TN carrier provided by a T-TRP 170. It is known that responsive to detecting a BF, the UE 110 may go through a cumbersome BFR procedure on the TN carrier. Rather than go through the cumbersome BFR procedure, the UE 110 in the multi-carrier TN/NTN cell may select from among multiple BFR options. In one BFR option, the UE 110 may directly indicate a selected RS to the T-TRP 170 through the multi-carrier TN/NTN cell. In another option, the UE 110 may transmit feedback to the T-TRP 170 through the multi-carrier TN/NTN cell. The feedback may include a measurement report that includes measurement information on a set of RSs. Responsive to receiving the feedback, the T-TRP 170 may determine, from the feedback, a preferred new beam to replace the failed beam. The T-TRP 170 may then resume data transmission to the UE 110 using the preferred new beam. It may be shown that, when the T-TRP 170 resumes data transmission to the UE 110 using the preferred new beam, the T-TRP 170 reduces BFR latency relative to traditional, cumbersome BFR procedures. Conveniently, it may be shown that data interruption may be minimized or avoided altogether.

Aspects of the present application relate to introducing a cross-carrier or cross-link BFR procedure or a cross-BWP BFR procedure within a multi-link shared carrier TN/NTN cell or a multi-carrier TN/NTN cell. Notably, neither cross-carrier BFR procedures nor cross-BWP BFR procedures are supported by current NR specifications. It may be shown that current NR specifications do not even support cross-BWP BFR procedures within a single cell.

Implementing a cross-BWP BFR procedure within the multi-carrier TN/NTN cell may involve configuring candidate RSs (i.e., q1). The configured candidate RSs may include RSs located within multiple BWPs of the multi-carrier TN/NTN cell (e.g., TN BWPs and NTN BWPs). To include RSs located within multiple BWPs may involve defining measurement gaps for the UE 110 to measure candidate RSs outside of an active BWP or active carrier within the multi-carrier TN/NTN cell. The PRACH resource associated with the candidate RSs (q₁) may be defined outside the active BWP or, even, may be defined outside the active carrier type. For example, when the UE 110 is operating in the context of a BWP of a TN carrier, the PRACH resource associated with the candidate RSs (q₁) may be defined for an BWP of an NTN carrier. A BFR search space, recoverySearchSpace, may be defined.

Subsequent to indicating, to the T-TRP 170, a requested recovery beam, q_{new}, the UE 110 may monitor the BFR search space, recoverySearchSpace, to receive, from the T-TRP 170, a BFR response using the requested recovery beam, q_{new}. Notably, the requested recovery beam, q_{new}, may be a beam that is defined outside the active BWP or, even, may be defined outside the active carrier type.

Monitoring, by the UE 110, may be configured to start from time slot n+4+K, where n is the time slot in which the UE 110 has transmitted the BFR request and K is a timing gap which takes into account a propagation delay difference between TN and NTN.

Aspects of the present application relate to shared carrier operation.

In case of shared carrier operation, the TN and the NTN can operate in different frequency resources of the shared carrier. The operation in different frequency resources may be shown to come at the cost of some performance degradation. These costs may be expressed in terms of latency and lack of flexibility in assigning resources to the UE 110.

For example, operation in different frequency resources means that the TN and the NTN are configured to operate on non-overlapping UL BWPs and non-overlapping DL BWPs.

For the TN and the NTN to operate on the same frequency resources (e.g., shared BWP), it is expected that the UE 110 will receive an indication regarding whether a particular frequency band is shared between the TN and the NTN. The UE 110 may receive the indication over dynamic signaling (MAC CE or DCI) or RRC signaling (common signaling or dedicated signaling).

For shared carrier operation, the TN and the NTN are expected to use orthogonal pilot signals.

The NTN may use so-called common pilot signals.

The configuration of the common NTN pilot signals may be signaled to all UEs in the multi-carrier TN/NTN cell using RRC broadcast signaling.

A given UE 100 may use the common pilot signal configuration to receive NTN channels.

In a case wherein the NTN PDSCH overlaps, in frequency, with the TN PDSCH, the UE 110 may be configured to jointly decode the two PDSCHs. The UE 110 may cancel interference from the NTN PDSCH using the common pilot configuration.

A PDSCH received on a TN DL and a PDSCH received on an NTN DL may overlap in time resources, overlap in frequency resources or overlap in code resources. The UE 110 may still try to decode both sets of data using joint reception, notably interference cancellation, given that the two PDSCHs may be received with a high signal-to-noise differential. Also, the PDSCHs may be separated spatially. For example, a UE 110 may employ different antenna panels/beams to receive PDSCHs simultaneously on a TN DL and on an NTN DL (here, the NT-TRP 172 may be implemented as a drone). A shared carrier or cell may also allow simultaneous usage of shared carrier resources. For example, the UE 110 may be configured to rate match a TN PDSCH or PDCCH based on resources used to transmit SSBs of NTN or common RS of NTN, if configured, and vice versa. The UE may also be able to rate match a scheduled TN PDSCH or detected PDCCH around any resources configured for NTN on the shared carrier. Such resources may include RS resources (e.g., CSI-RS, PT-RS, SRS) or control resource sets (CORESETs). Rate matching can be carried out at the resource-element (RE) level or at the resource block-symbol (RB-symbol) level. If rate matching is carried out at the RE level, it means that, when decoding PDSCH/PDCCH, the UE will consider the subset of REs corresponding to the configured or indicated resources as not available for PDSCH/PDCCH transmission. This implies the UE will skip those resources elements when decoding the PDSCH/PDCCH. If rate matching is carried out at the RB-symbol level, it implies that when decoding PDSCH/PDCCH, the UE will consider the subset of RB-symbol resources corresponding to the configured or indicated resources as not available for PDSCH/PDCCH transmission. This implies the UE will skip those RB-symbol resources when decoding the PDSCH/PDCCH.

In contrast to a conventional cell, wherein carrier resources are exclusively dedicated for a terrestrial system (wherein the gNB is fixed on the ground) or a non-terrestrial system (wherein the gNB is aboard an NTN platform, e.g., satellite/HAPS/drone), aspects of the present application introduce a shared TN/NTN serving cell/carrier, wherein carrier/spectrum resources are shared between TN and NTN links. The shared cell may be accessed by the UE during initial access or may be configured to the UE as one cell in a set of aggregated cells in a carrier aggregation (CA) or dual-connectivity (DC) framework. The spectrum resources may be dynamically scheduled, to the UE 110, by the TN or by the NTN. The UE 110 may then follow a certain behavior when transmitting/receiving control, data and reference signals (RSs) on the shared serving cell. For example, downlink control or data channels, e.g., PDSCHs from TN links and NTN links, can overlap on time/frequency/code resources and UE can still try to decode both PDSCHs using joint reception, interference cancellation or rate matching techniques.

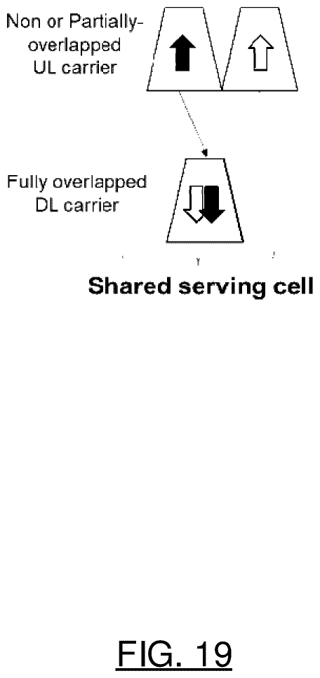

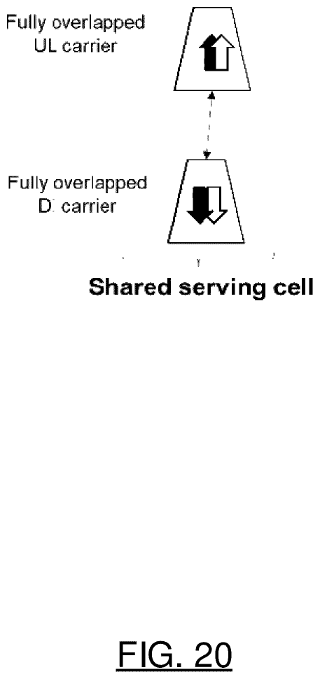

The shared cell may be considered to be a case of a multi-carrier cell, wherein two DL CCs are partially or fully overlapped. In a multi-link shared cell, the links may have a link type, with one link type being a terrestrial network link type and another link type being a non-terrestrial network link type. In this case, it is possible that the DL carrier is fully overlapped and the UL carriers are not overlapped at all (see FIG. 19) or that both DL and UL carriers are also partially or fully overlapped (see FIG. 20).

Aspects of the present application relate to initial and/or random access procedures for UEs in RRC Idle/Inactive state trying establish a connection with a shared serving cell.

A UE 110 in RRC Idle state or RRC Inactive state may receive an indication that a serving cell is a shared, multi-link TN/NTN cell using common signaling, either in a MIB as part of synchronization signals/PBCH blocks (SSB) or in system information block 1 (SIB1) as part of remaining system information (RMSI). The indication may specify that the serving cell is a serving cell with dynamic, shared-spectrum access through links of a first link type and links of a second link type. That is, it may generally be understood that a UE 110 has information regarding whether a given serving cell is a shared TN/NTN cell before the UE 110 initiates random access to the given serving cell. It follows that the given UE 110 may decide to camp on a shared serving cell before initiating random access to that serving cell in situations wherein the UE 110 has received a DL paging message on either TN links or NTN links or the UE 110 has UL data to transmit. The UE 110 in RRC Idle state or in RRC Inactive state may have completed a cell selection/reselection process and may have chosen to camp on the shared serving cell. The UE 110 then monitors system information and (in most cases) paging information from the multi-link serving cell. Note that the services may be limited and that the PLMN may not be aware of the existence of the UE 110 within the multi-link serving cell.

A TRP may transmit SSBs in different frequency locations or in different bandwidth parts of the shared DL CC, with one or more of the SSBs being cell-defining SSB (CD-SSBs). For a shared cell, CD-SSBs may be transmitted only on a TN link or only on an NTN link or both on a TN link and on an NTN link. The location of the CD-SSBs within the shared DL CC may be cross-link indicated, i.e., a non-cell-defining SSB transmitted by a T-TRP 170 on a TN link may indicate the location of a CD-SSB transmitted by an NT-TRP 172 on an NTN link and vice versa.

Multi-link TN/NTN cell system information transmitted via MIB and SIB1 (e.g., RMSI) may provide separate RACH configurations for the different TRP node types (i.e., link types). For example, one RACH configuration may be provided for the T-TRP 170 (corresponding to a TN link type) and another RACH configuration may be provided for the NT-TRP 172 (corresponding to an NTN link type). The multi-link TN/NTN cell system information may also provide an indication regarding whether the shared serving cell has overlapped UL carriers (see FIG. 19) or non-overlapped UL carriers (see FIG. 20).

Consider that a given serving cell is a shared TN/NTN cell and that a UE 110 supports operation in the shared TN/NTN cell for a given band combination. That is, the UE 110 has indicated, to the TRP 170/172, a capability of operating in a shared serving cell for the given band combination. The UE 110 may carry out initial access either in the TN UL carrier, in the NTN UL carrier or in the shared UL carrier either using the TN RACH configuration or using the NTN RACH configuration.

Consider that a given serving cell is a shared TN/NTN cell operating in an UL carrier aggregation mode and that a UE 110 supports operation in the shared TN/NTN cell for a given band combination. That is, the UE 110 has indicated, to the TRP 170/172, a capability of operating in a shared serving cell for the given band combination. The UE 110 may carry out initial access on the TN UL carrier or on the shared UL carrier (see FIG. 20) using the corresponding RACH configuration responsive to the UE 110 detecting a TN SSB on the shared DL carrier with a reference signal received power above a certain threshold. Alternatively, the UE 110 may carry out initial access on the NTN UL carrier or on the shared UL carrier (see FIG. 20) using the corresponding RACH configuration responsive to the UE 110 detecting an NTN SSB on the shared DL carrier with a reference signal received power above a certain threshold. The reference signal received power threshold may be a link-specific threshold or carrier-specific threshold or common threshold across link types or carrier types.

Consider that a given serving cell is a shared TN/NTN cell operating in a supplementary UL mode and that a UE 110 supports operation in a shared TN/NTN cell for a given band combination. That is, the UE 110 has indicated, to the TRP 170/172, a capability of operating in a shared serving cell for the given band combination. The UE 110 may determine a type of RACH configuration to use for random access. The UE 110 may carry out the determining by comparing a measured RSRP of a detected SSB to a carrier-selection threshold or link-selection threshold. It may be considered that the carrier-selection threshold or link-selection threshold has been provided as part of the shared cell system information.

In this case, a further determination, by the UE 110, regarding an UL carrier or link to use for carrying out initial access (e.g., sending a preamble) may be based on comparing a measurement of RSRP for a selected SSB to a TN/NTN carrier-selection threshold provided in the cell system information via common signaling. Recall that examples of receiving information via common signaling include receiving information via MIB and receiving information via SIB1.

In the case of a shared DL carrier, the carrier-selection threshold may be considered to be a common threshold, Th_{Common}. If the measured RSRP of a detected SSB is lower than the common threshold, Th_{Common}, the UE 110 may select the TN carrier and/or use the TN RACH configuration for carrying out initial access. Otherwise, the UE may select the NTN carrier and/or use the NTN RACH configuration for carrying out initial access.

So-called “random access Message 3” may be transmitted, by the UE 110, on the same selected carrier in the case of non-overlapped UL carriers (see FIG. 19).

When the UE 110 is in the RRC Connected state, the UL carrier to use for carrying out random access may be explicitly configured to the UE 110 via UE-specific Layer 3 RRC signaling or dedicated Layer 3 RRC signaling.

In cases wherein a shared carrier is used, it may be shown that the TN and the NTN may operate in different frequency resources of the shared carrier with some costs. The costs include some performance degradation in terms of latency and reduced flexibility in assigning resources to a UE.

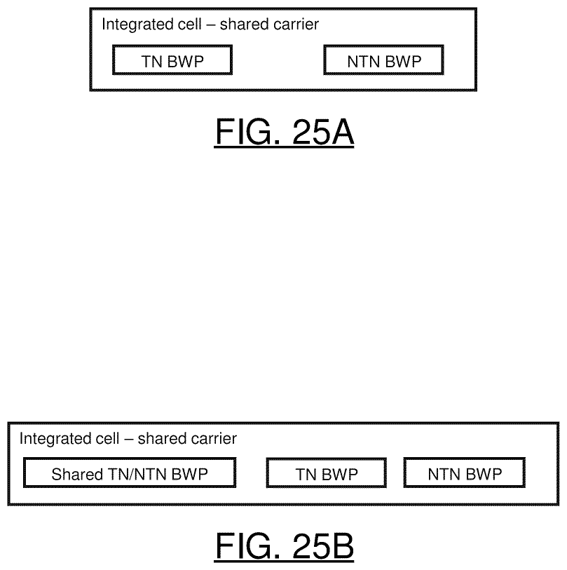

In one example, the TN and the NTN may be configured to operate on non-overlapping UL or DL BWPs (see FIG. 25A).

In another example, wherein the TN links and the NTN links are configured to operate on the same frequency resources (e.g., in a shared TN/NTN BWP, see FIG. 25B), several adaptations may be implemented. In one adaptation, an indication may be provided, to a UE 110, regarding a particular frequency band or bandwidth part (BWP) that is to be shared between the TN and the NTN. The indication may be provided through dynamic signaling (MAC CE or DCI) or RRC signaling (common signaling or dedicated signaling). In another adaptation, the TN and the NTN may be configured to use orthogonal pilot signals. An example pilot signal is a demodulation reference signal (DM-RS), which may be transmitted on the shared BWP. Orthogonal RSs can correspond to DM-RSs in the same or different code division multiplexing (CDM) groups. In one example, a configuration for an NTN DM-RS may be signaled, using RRC broadcast signaling, to all UEs 110 in a shared cell. A given UE 110 may use the common RS configuration to decode and receive the NTN channels, where the NTN channels include an NTN PDCCH and an NTN PDSCH.

In a case wherein the NTN PDSCH overlaps, in frequency and/or time, with a TN PDSCH (e.g., the NTN PDSCH and the TN PDSCH are transmitted on overlapping physical resource blocks, or “PRBs,” in the same time slot), the UE 110 may jointly receive the two PDSCHs using joint reception techniques. Example joint reception techniques include successive interference cancellation (SIC). In SIC, the UE 110 may first decode the NTN PDSCH based on the received signal over the resource elements (RE)s of the PRBs constituting the NTN PDSCH using the NTN DM-RS. The UE 110 may then subtract, from the received signals, the contribution of the NTN PDSCH that overlaps with the TN PDSCH. The UE 110 may subsequently decode the TN PDSCH based on updated received signal over the REs of the PRBs constituting the TN PDSCH using the TN DM-RS.

It may be that the overlapping TN/NTN PDSCHs are separated spatially, e.g., the UE 110 may employ different antenna panels/beams to receive the two PDSCHs simultaneously from the TN links and from the NTN links (here, the NT-TRP 172 may be a drone). Similarly, the UE 110 may transmit a TN PUSCH and an NTN PUSCH on the same shared UL carrier BWP using different transmission beams or spatial filters using the same panels or different panels. The TRP 170/172 may signal, to the UE 110, an indication of which beam to use to use to transmit the TN PUSCH and which beam to use to use to transmit the NTN PUSCH simultaneously. Alternatively, the TRP 170/172 may signal, to the UE 110, an indication to expect to receive overlapping TN PDSCH and NTN PDSCH on the same time/frequency resources. The signaling may be carried out through UE-specific RRC signaling, MAC CE, DCI in PDCCH, or a combination thereof. The spatial indication for a TN beam may be expressed in the form of a QCL of a DM-RS with another DL RS. Alternatively, the spatial indication for a TN beam may be expressed in the form of an indication of a TCI state index among a list of pre-configured TCI states. The spatial indication for an NTN beam may be in the form of a beam-specific BWP. The UE 110 may also estimate an NTN transmit beam direction or an NTN receive beam direction based on the location of the UE 110 in combination with information indicating a location for the NT-TRP 172 (e.g., a satellite or a drone).

Aspects of the present application relate to shared carrier operation that allows for simultaneous usage, and dynamic sharing, of shared carrier/BWP spectrum resources between TN and NTN.

A UE 110 may be configured to rate match TN PDSCH around resources used to transmit NTN signals and channels (e.g., SSBs, reference signals or CORESETs) and vice versa.

In aspects of the present application, UEs 110 and/or T/NT-TRPs 170/172 may perform rate matching or puncturing or shortening in sets of resources of a shared DL/UL carrier/BWP, where the sets of resources are configured or dynamically allocated for TN signals or channels to compensate for resources that carry NTN control, data or reference signals and channels. Rate matching may be performed by increasing a coding rate on remaining resources to compensate for blanking or otherwise not transmitting/receiving TN signals, over a subset of resources that carry NTN signaling or vice versa.

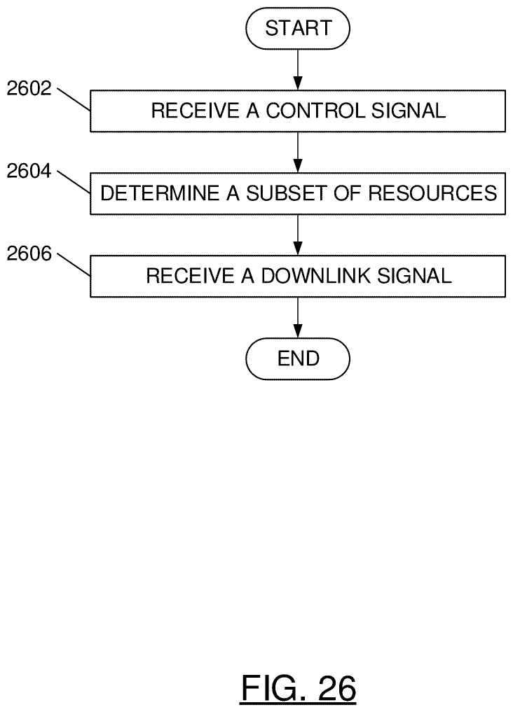

FIG. 26 illustrates example steps in a method, carried out at a UE 110 in RRC Connected state, for receiving signals in a shared TN/NTN carrier. The UE 110 may, initially, receive (step 2602) a control signal indicating an NTN parameter. The UE 110 may determine (step 2604), based on the NTN parameter, a subset of resources among a set of resources in the shared carrier/BWP carrying NTN signal(s). The UE 110 may then receive (step 2606) a TN downlink signal over one or more remaining resources in the set of resources. In one example, the set of resources includes resources that are allocated/assigned to the UE 110 for TN PDSCH reception or granted to the UE 110 for TN PUSCH transmission. In the same example, or in another example, the set of resources may include NTN control resource sets (CORESETs) configured to the UE 110 via RRC signaling. In any one of the preceding examples, or in another example, the TN downlink or uplink signal may be rate matched around the subset of resources carrying the NTN signal(s).

The TN signal or channel may be rate matched at the resource element (RE) level such that the subset of resources around which the NR downlink signal is rate matched includes an integer number of REs. The NR signal or channel may be rate matched at the resource block (RB)-symbol level, where the term “RB” may be understood to refer to any finite set of consecutive REs, usually 12 REs in LTE and NR, and the term “symbol” refers to one OFDM symbol such that the subset of resources around which the TN downlink signal may be rate matched includes a set of RBs in a number of OFDM symbols in a slot.

The control signal received in step 2602 may indicate a RS configuration and/or an antenna port. In such an example, the UE 110 may determine (step 2604) the subset of resources carrying NTN signal(s) by determining, based on the indicated RS pattern or based on the indicated antenna port, that the subset of resources includes resources carrying NTN reference signals.

The control signal received in step 2602 may indicate a frequency offset. In such an example, the UE 110 may determine (step 2604) the subset of resources carrying NTN signal(s) by determining that the subset of resources includes resources carrying NTN reference signal(s) based on the indicated frequency offset.

The control signal received in step 2602 may indicate a bitmap of Orthogonal Frequency Division Multiplexed (OFDM) symbols in a slot. In such an example, the UE 110 may receive (step 2606) the TN signal over one or more remaining resources in the set of resources by adjusting the start time for receiving a TN downlink signal for a period of time corresponding to the number of OFDM symbols in the slot. The control signal 2602 may also indicate a bitmap of RB-symbol resources in a given time-frequency region, e.g., a BWP in a given slot or frame.

The control signal received in step 2602 may indicate an NTN CSI-RS or SRS configuration. In such an example, the UE 110 may determine (step 2604) the subset of resources carrying NTN signal(s) by determining that the subset of resources includes resources carrying NTN CSI-RS signal(s) based on the NTN CSI-RS configuration.

The UE 110 may receive (step 2606) the TN signal by receiving one or more TN signals over the one or more remaining resources, where the one or more TN signals have zero power levels over the subset of resources carrying the NTN downlink signal(s). In such an example, the one or more NTN downlink signals may include an NTN signal transmitted over a PDSCH, an NTN control signal transmitted over a PDCCH, an NTN primary synchronization signal, an NTN secondary synchronization signal, an NTN broadcast signal transmitted over an NR PBCH or a combination thereof.

The UE 110 may receive (step 2602) the control signal over a PDCCH. The UE 110 may receive (step 2602) the control signal over a PBCH. The UE 110 may receive (step 2602) the control signal included in RMSI. The UE 110 may receive (step 2602) the control signal as conveyed by a higher-layer UE-specific RRC signal or a dedicated RRC signal. The UE 110 may receive (step 2602) the control signal as conveyed by a MAC-CE. The UE 110 may receive (step 2602) the control signal as conveyed by a combination of a higher-layer RRC signal and a MAC-CE.

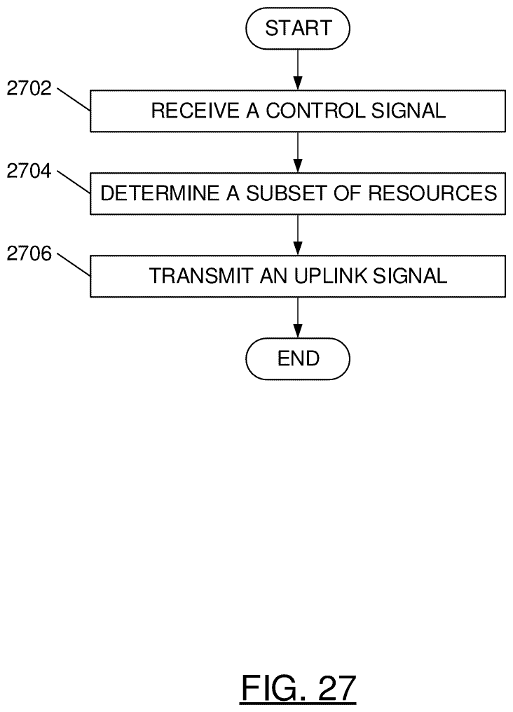

FIG. 27 illustrates example steps in a method, carried out at a UE 110, of transmitting signals in a shared TN/NTN carrier. The UE 110 may, initially, receive (step 2702) a network control signal indicating an NTN parameter. The UE 110 may determine (step 2704), based on the NTN parameter, a subset of resources carrying, or otherwise reserved for, NTN signals. The UE 110 may then transmit (step 2706) a TN uplink signal over one or more remaining resources in a set of resources without transmitting the NTN uplink signal over the subset of resources carrying, or otherwise reserved for, the NTN signals. In one example, the set of resources are allocated to the UE 110. The set of resources may include resources configured for uplink control signals. The TN uplink signal transmitted in step 2706 may be rate matched around the subset of resources carrying, or otherwise reserved for, NTN signals. The UE 110 may determine (step 2704) the subset of resources carrying NTN signals by determining, based on the NTN network parameter in the control signal, that at least some resources in the subset of resources are reserved for NTN RACH transmissions. The UE 110 may determine (step 2704) the subset of resources carrying NTN signals by determining, based on the NTN network parameter in the control signal, that at least some resources in the subset of resources carry NTN SRS symbols. The UE 110 may determine (step 2704) the subset of resources carrying NTN signal(s) by determining, based on the NTN network parameter in the control signal, that at least some resources in the subset of resources carry NTN data signal transmitted over a PUSCH or a control signal transmitted over a PUCCH.

A UE communication that is scheduled to occur in a shared cell may be carried out in the UL direction (e.g., in a PUSCH) and/or may be carried out in the DL direction (e.g., in a PDSCH). Furthermore, the UE communication that is scheduled to occur in a shared cell may be carried out using time/frequency resources that have been indicated, to the UE 110, in DCI carried by a PDCCH in a CORESET of a shared DL carrier. A one-bit scheduling type indication in the DCI in PDCCH carrying a DL assignment may indicate whether the PDSCH is a TN PDSCH or an NTN PDSCH. Similarly, a one-bit scheduling type indication in DCI carrying an UL grant may indicate whether the PUSCH is a TN PUSCH or an NTN PUSCH. The one-bit scheduling type indication may implicitly indicate some NTN-specific scheduling parameters for the reception of NTN PDSCH or transmission of NTN PUSCH. The NTN-specific scheduling parameters may include a timing gap of K time slots in the numerology of the shared DL carrier or the shared UL carrier. In the case of non-overlapping UL carrier, the one-bit scheduling type indication may implicitly indicate which UL carrier to use for the PUSCH transmission. The one-bit scheduling type indication may also implicitly indicate, to the UE 110, a QCL indication or TCI state associated with a TN DL channel or spatial filtering associated with a TN UL channel and a transmit/receive beam or beam-specific BWP associated with the NTN channels.

The UE communication that is carried out in the UL direction may include a link type (TN/NTN) indicator. The UE communication that is carried out in the UL direction may include a Channel Quality Indicator (CQI). The UE communication that is carried out in the UL direction may include a hybrid automatic repeat request (HARQ).

Cell (Definition 1): Radio network object that can be uniquely identified by a User Equipment from a (cell) identification that is broadcasted over a geographical area from one UTRAN Access Point. A Cell is either FDD or TDD mode.

Cell (Definition 2): Combination of downlink and optionally uplink resources. The linking between the carrier frequency of the downlink resources and the carrier frequency of the uplink resources is indicated in the system information transmitted on the downlink resources.

Serving Cell: For a UE in RRC_CONNECTED not configured with CA/DC there is only one serving cell comprising of the primary cell. For a UE in RRC_CONNECTED configured with CA/DC the term “serving cells” is used to denote the set of cells comprising of the Special Cell(s) and all secondary cells.

Master Cell Group (MCG) For a UE configured with dual connectivity, the group of serving cells associated with the master gNB (MgNB), comprising of the PCell and optionally one or more SCells.

Secondary Cell (SCell): For a UE configured with CA, a cell providing additional radio resources on top of Special Cell.

Primary Cell (PCell): The MCG cell, operating on the primary frequency, in which the UE either performs the initial connection establishment procedure or initiates the connection re-establishment procedure.

Secondary Cell Group (SGC): For a UE configured with dual connectivity, the subset of serving cells comprising of the PSCell and zero or more secondary cells.

Special Cell: For Dual Connectivity operation the term Special Cell refers to the PCell of the MCG or the PSCell of the SCG, otherwise the term Special Cell refers to the PCell.

Carrier: The modulated waveform conveying the E-UTRA, UTRA or GSM/EDGE physical channels.

Carrier frequency: center frequency of the cell.

UE Camped on a cell: The UE is in idle mode and has completed the cell selection/reselection process and has chosen a cell. The UE monitors system information and (in most cases) paging information. Note that the services may be limited, and that the PLMN may not be aware of the existence of the UE within the chosen cell.

Radio Network Temporary Identifier: A Radio Network Temporary Identifier is a generic term of an identifier for a UE when an RRC connection exists. Following types of RNTI are defined: Cell RNTI (C-RNTI), Serving RNC RNTI (S-RNTI), UTRAN RNTI (U-RNTI) and GERAN RNTI (G-RNTI).

Cell Radio Network Temporary Identifier (C-RNTI): The C-RNTI is a UE identifier allocated by a controlling RNC and it is unique within one cell controlled by the allocating CRNC. C-RNTI can be reallocated when a UE accesses a new cell with the cell update procedure.

According to 3GPP, RP-193234, “Solutions for NR to support non-terrestrial networks (NTN),” 3GPP TSG RAN meeting no. 86, December 2019, available at www.3gpp.org, non-terrestrial networks refer to networks, or segments of networks, using an airborne or spaceborne vehicle for transmission. Spaceborne vehicles include Satellites (including Low Earth Orbiting (LEO) satellites, Medium Earth Orbiting (MEO) satellites, Geostationary Earth Orbiting (GEO) satellites as well as Highly Elliptical Orbiting (HEO) satellites). Airborne vehicles include High Altitude Platforms (HAPs) encompassing Unmanned Aircraft Systems (UAS) including Lighter than Air UAS (LTA), Heavier than Air UAS (HTA), all operating in altitudes typically between 8 and 50 km, quasi-stationary.

Terrestrial networks (TNs) include conventional cellular networks such as NR and LTE etc. Airborne TRPs (typically ˜100 m), which can be deployed on-board UAV/drone-type vehicles, can typically be considered part of TN or NTN depending on whether they connect to the core networks directly or through the NTN.

Many use case scenarios call for multi-connectivity between TN and NTN. Examples include on-demand, big-event, ad hoc facilities in underserved areas, urban areas and sub-urban areas. Passengers on board public transport vehicles (e.g., high-speed/regular train, bus, boat) may benefit from NTN broadband connectivity combined with TN cellular access.

In a multi-carrier terrestrial and non-terrestrial network, service coverage of terrestrial cellular network can be extended and user experience/quality of service can be enhanced. For example, terrestrial nodes can offer primary service whereas non-terrestrial nodes (e.g., HAPS/satellite) can provide global seamless coverage and flying TRPs (e.g., drones) can allow for an on-demand-based regional service boost. Joint operation of TN and NTN can provide a 3D wireless communication system experience to the UEs served by a multi-carrier, terrestrial and non-terrestrial network/system.

Carrier aggregation (CA) increases the user throughput by configuring the mobile terminal to be simultaneously connected with multiple serving cells or component carriers (CCs) of a serving node (e.g., a gNB), which enables the UE to transmit and receive data at multiple frequencies (e.g., cells or component carriers) simultaneously.

With Dual Connectivity (DC), the UE can be simultaneously connected to two serving nodes, for example to the master node (MN) and to the secondary node (SN). Serving nodes can belong to the same RAT (e.g., LTE or NR) or different RATs (LTE-NR DC or MRDC). DC and CA can be used in conjunction to one another, in which case the UE is connected to two serving nodes and is configured with multiple cells in each of them (i.e., the master cell group (MCG), and the secondary cell group (SCG).

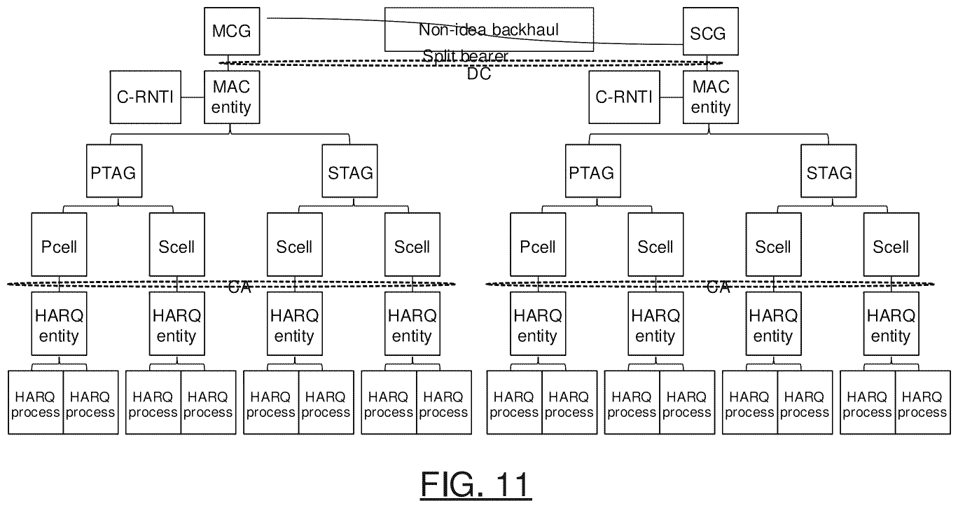

Features of Carrier aggregation (CA)—Ideal backhaul, same RAT include one MAC entity with multiple HARQ entities each with multiple HARQ processes, more than one HARQ process for one/two TB to one RNTI related UL and/or DL channel in one time instance, only one primary cell for more than one serving cell and one C-RNTI and multiple cells. (see FIG. 11)

Features of Dual connectivity (DC)—Non-ideal backhaul, same or different RAT include two MAC entities, each having one or more HARQ entities with multiple process, more than one HARQ process for one/two TB to one RNTI, related UL and/or DL channel in one time instance and two primary cells for more than one serving cell, two C-RNTIs. (see FIG. 11)

Current solutions for beam management procedures in cellular systems are based on beam sweeping for Initial Access, physical layer beam measurements (e.g., so-called L1-RSRP and L1-SINR), beam failure detection and beam failure recovery. All these procedures are referred to as “mobility within a cell” and thus don't extend beyond the coverage area corresponding to a cell.

Beam Failure Detection (BFD) procedure in cellular systems are based on monitoring the quality of the link of the serving cell by the UE. The UE detects and measures BFD reference signals, based on those measurement it compares the quality of the BFD-RS to a hypothetical PDCCH Block Error Rate (BLER). If the quality of the measurement on the BFD-RS is below the hypothetical PDCCH BLER, then a Beam Failure Instance (BFI) is considered to have taken place. A “beam failure” is considered to have been detected when several consecutive BFIs have occurred.

Beam Failure Recovery (BFR) procedure in cellular systems is based on initiating the search for a new serving beam by the UE, after a beam failure has been detected on the serving beam. A UE is configured with so-called “candidate beams,” which the UE attempts to detect and measure as it looks for the best beam out of those candidate beams. If the quality of the best beam is above a certain threshold, the UE then initiates Random Access in order to complete the BFR procedure.

Aspects of the present application focus on methods for shared/multi-carrier cell concept in so-called integrated terrestrial and non-terrestrial networks which comprise both terrestrial and non-terrestrial serving nodes (gNBs) and associated terrestrial and non-terrestrial TRPs.

Aspects of the present application relate to a solution for integrating terrestrial and non-terrestrial networks into a single radio communication system/network. In doing so, aspects of the present application may be shown to solve many issues related to the integration of TN and NTN.

It may be considered that DC/CA do not provide a suitable framework for an integrated TN/NTN solution because different carriers in DC/CA correspond to different cells, which induces a lot of unnecessary handovers, among other drawbacks, such as increased latency to activate and deactivate carriers, etc.

In addition, CA mechanism only benefits the UEs in Connected state, i.e., UEs having completed RRC connection with the network, but not UEs in Idle mode/Inactive state (e.g., UEs that have yet to carry out initial access procedures).

In the context of a multi-carrier Terrestrial and Non-Terrestrial system, aggregating the throughput of multiple carriers might be more useful in DL rather than UL. Indeed, due to the large distance and consequently large propagation delay between satellites and UEs on the ground, typically, the goal in UL is to optimize coverage, save UE power consumption and reduce UE complexity. Therefore, allowing flexibility between UL carrier aggregation and supplementary UL operation may be shown to be beneficial. This calls for decoupling of UL and DL carriers and a flexible linkage between UL and DL carriers.

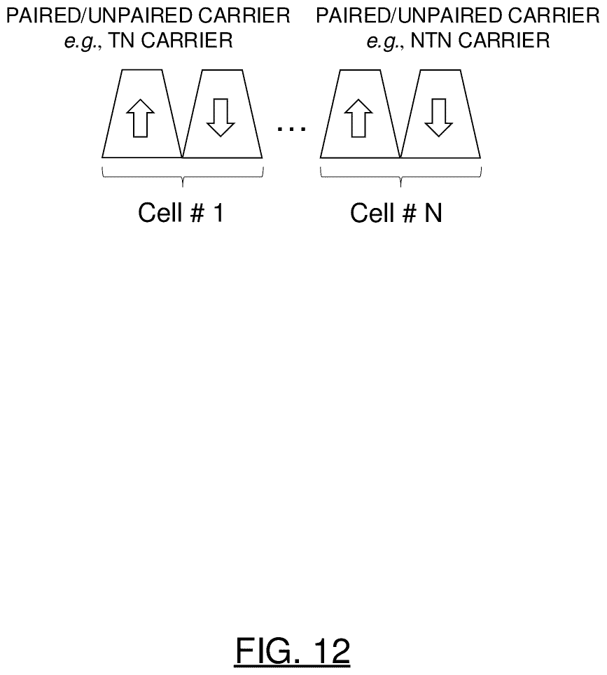

FIG. 12 illustrates a representation of UL carriers and DL carriers in distinct cells.

One problem has to do with the inherently time-consuming aspects of Beam Management procedures in 5G NR. Typically, Beam Management functions such as BFD and BFR are restricted to the serving cell. The serving cell may be a terrestrial serving cell or a non-terrestrial serving cell. Even then, it takes a significant amount of time for UEs to find a usable candidate beam. The significant amount of time can result in data sessions getting dropped in time-sensitive scenarios.

Another problem has to do with restricted scope of the current Beam Management procedures in 5G NR, which restricted scope limits the efficiency of the current Beam Management procedures. Since Beam Management procedures are limited to the serving cell, candidate beams are limited to the serving cell and, therefore, a UE doesn't look for beam from neighbor TRPs or even non-terrestrial TRPs. If no suitable candidate beam is found, the UE just selects a beam randomly from the terrestrial beams of the serving cell, if the serving cell is a terrestrial serving cell, or the UE selects a beam randomly from the non-terrestrial beams of the serving cell, if the serving cell is a non-terrestrial serving cell.

Another problem has to do with the reactive nature of Beam Management procedures in 5G NR. When the last serving beam pair link fails, it is already too late for the UE to recover from the impact and it follows that the UE has to spend time finding a suitable candidate beam. Moreover, the serving cell cannot assist the UE in its Beam Management process when all of the beam pair links of the terrestrial/non-terrestrial serving cell have failed.

In NR, synchronization signals/PBCH blocks (SSB)s are cell-specific, in the sense that they carry the physical layer cell ID (PCID) of the cell. They are organized in burst sets which are transmitted periodically. Different SSBs are beamformed, i.e., different SSBs are transmitted in different spatial directions spanning the area served by TRPs of a serving cell and spanning the coverage area of that cell. Each SSB occupies 240 subcarriers (frequency domain) and 4 symbols (time domain) and contains primary and secondary synchronization signals (PSS and SSS) and the physical broadcast channel (PBCH). PSS and SSS together carry the physical cell identity (PCID) and the PBCH carries the Master Information Block (MIB) and some other payload bits. Within the frequency span of a carrier, multiple SSBs in different frequency locations can be transmitted which do not need to carry the same PCID. However, there is a cell-defining SSB (CD-SSB) has a unique location within the carrier which intersects which the SSB synchronization raster defined for the frequency band of the cell. The CD-SSB carries the unique PCID of the cell and has an associated RMSI, i.e., indicates the time-frequency location of control resource set (CORESET #0) which the UE has to monitor for decoding PDCCH/PDSCH carrying the RMSI. SSBs which are not CD-SSBs can indicate the frequency location of the CD-SSB on the same carrier.

A given UE can be configured with multiple RSs for BFD on different carriers (e.g., q_{0,TN} and q_{0,NTN}).

Beam failure is detected when the quality of the beams in a given BWP measured through the corresponding BFD RS, q₀, drops below a certain threshold, Q_{out,LR}, in which case the UE keeps monitoring/measuring the quality of current beams/RSs (i.e., q₀) as well as new candidate beams (i.e., q₁).

When certain conditions are met, the UE switches the beam to one of the beams selected from q₁/q_{new}, via an associated PRACH resource configuration.

When Beam Failure is detected by the UE in a given BWP of a given carrier of the multi-carrier serving cell, the UE goes through the list of candidate beams belonging to the corresponding BWP and picks the RS whose L1-RSRP measurement is above a threshold, Q_{in,LR}, which threshold may also be referred to as rsrp-ThresholdSSB.

After the UE has found a suitable RS, the UE performs Contention-Free/Contention-based RACH in order to indicate the selected RS to the serving cell and waits for the RACH response on the search space indicated by recoverySearchSpaceId.

If a RACH response is received before ra-ResponseWindow has expired, BFR is considered successful.

Aspects of the present application relate to a multi-carrier serving cell, which enables a flexible, multi-connectivity framework between TN carriers and NTN carriers. Within the multi-carrier serving cell, UL carrier and DL carriers in paired spectrum (FDM) or impaired spectrum (TDM) are decoupled from each other. Multiple DL carriers can be configured within a single cell (i.e., a multi-carrier serving cell) and each UL carrier can be associated with, or linked to, multiple DL carriers.

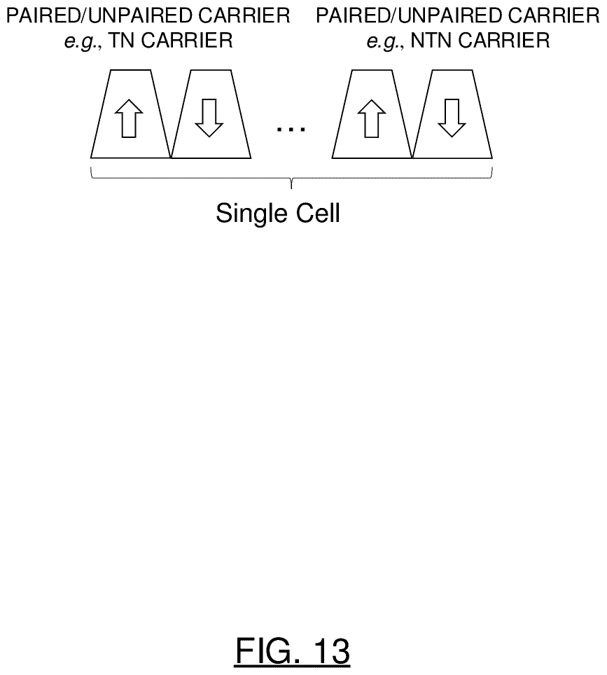

FIG. 13 illustrates a representation of UL carriers and DL carriers in a single, multi-carrier serving cell.

The multi-carrier serving cell can be associated with multiple contiguous/non-contiguous DL carriers, including: intra-band contiguous carriers; intra-band non-contiguous carriers; inter-band carriers; and a mix of intra-band contiguous/non-contiguous carriers and inter-band carriers.

The multi-carrier cell can also have a single shared carrier between TN and NTN.

UEs in Idle/Inactive states can connect to the multi-carrier serving cell via either TN carrier or NTN carrier or shared TN/NTN carrier.

Once UEs are connected to the multi-carrier serving cell, the UEs can have access to all the carrier types without the need for small cell addition, releasing, activation, (mobility) measurement, etc. Besides, layer-1/2 beam-level mobility including signaling and measurements may be used to control UE mobility within the multi-carrier cell, instead of layer-3 signaling and measurement filtering required for layer-3 handover.

For a multi-carrier serving cell, each UL carrier can be associated with/linked to more than one physical DL carrier, i.e., an UL TN carrier can be linked to a DL TN carrier and a DL NTN carrier. The linking between the carrier frequency/frequencies of the downlink resources from the shared DL carrier or multiple DL carriers of the multi-carrier serving cell and the carrier frequency or frequencies of the uplink resources of the shared UL carrier or multiple UL carriers of the multi-carrier serving cell may be indicated in system information transmitted on the downlink resources of each DL carrier or one of the DL carriers of the multi-carrier serving cell.

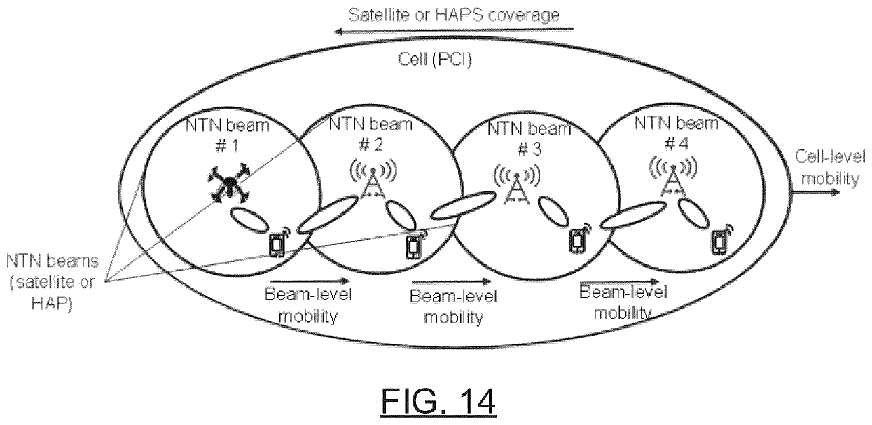

FIG. 14 illustrates a representation of a difference between cell-level mobility and beam-level mobility.

Component carriers belonging to a multi-carrier cell can be TDD (unpaired carrier) or FDD (paired carrier). There could be different options on how the different component carriers belonging to a multi-carrier cell are linked or associated.

In Option 1-1 (see FIG. 15), each UL component carrier (CC) is associated with one default DL CC and (at least) one non-overlapping supplementary DL CC.

In Option 1-2 (shared DL carrier, see FIG. 16), the two DL CCs are partially or fully overlapped. In Option 1-2, it is possible the DL carrier is fully overlapped and the UL carriers are not overlapped at all.

In Option 2-1 (see FIG. 17), the two DL CCs are aggregated into a single DL virtual carrier (VC) and each UL CC is associated with the single DL VC. For example, TN UL carrier and NTN UL carrier share the same DL virtual carrier.

In Option 2-2 (see FIG. 18), the two DL CCs are aggregated into a single DL virtual carrier (VC) and the two UL CCs are aggregated into a single UL virtual carrier (VC).

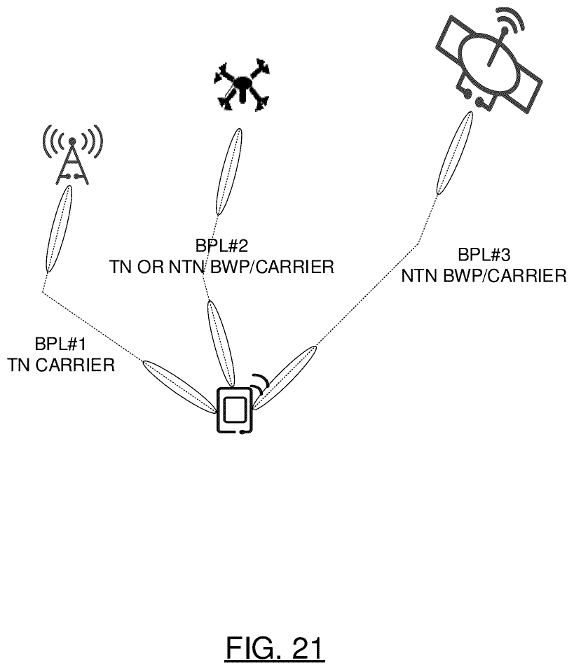

In each of the following embodiments, we describe a network made of different wireless devices such as fixed TRPs, drones and satellites, as shown in FIG. 21.

It is also assumed that UEs are configured to make measurements during measurement intervals. In each measurement interval within a BWP corresponding to one DL carrier, the UE can detect and measure reference signals corresponding to one BPL and can detect up to one BFI per measurement interval and per BPL.

In the following embodiment, we describe an example of initial and or random access procedures for UEs in RRC Idle/Inactive state trying establish a connection with a multi-carrier serving cell.

For UEs in RRC Idle or Inactive state, whether a cell is a multi-carrier TN/NTN cell can be broadcast using common signaling either in MIB as part of synchronization signals/PBCH blocks (SSB) or in system information block 1 (SIB1) as part of remaining system information (RMSI), i.e., the UE knows whether a cell is a multi-carrier TN/NTN cell before initiating random access to that cell. Therefore, UE could decide to camp on a multi-carrier serving cell before initiating random access to that cell if receiving a DL paging message or it has UL data to transmit. The UE in idle or inactive mode and has completed the cell selection/reselection process and has chosen to camp on the multi-carrier serving cell. The UE monitors system information and (in most cases) paging information from the multi-carrier serving cell. Note that the services may be limited, and that the PLMN may not be aware of the existence of the UE within the multi-carrier cell.

Each CC of the multi-carrier cell can have several SSBs allocated in different frequency locations or bandwidth parts, with one or more of them being cell-defining SSB (CD-SSBs). For a multi-carrier cell, CD-SSBs may be transmitted only from TN carrier or only from NTN carrier or both from TN and NTN carriers. The location of the CD-SSBs within the multi-carrier cell may be cross-carrier indicated, i.e., a non-cell-defining SSB in a carrier (e.g., a TN carrier) may indicate the location of a CD-SSB in another carrier (e.g., an NTN carrier).

The multi-carrier TN/NTN cell system information transmitted via MIB and SIB1 (i.e., RMSI) may provide separate RACH configurations for the different carriers (e.g., one RACH configuration for TN carrier and another RACH configuration for NTN carrier). It may also provide an indication of If the cell is a multi-carrier TN/NTN cell and the UE supports operation (i.e. UE is capable of operating) in a multi-carrier TN/NTN cell for the given band combination, UE can carry out initial access in either the TN UL carrier or the NTN UL carrier using the corresponding RACH configuration.

If the cell is a multi-carrier TN/NTN cell operating in a UL carrier aggregation mode and the UE supports operation in a multi-carrier TN/NTN cell for the given band combination, UE carries out initial access on the TN UL carrier using the corresponding RACH configuration if UE detects SSB in TN DL carrier above a certain threshold or UE carries out initial access on NTN UL carrier using the corresponding RACH configuration if UE detects SSB in NTN DL carrier above a certain threshold.

If the cell is a multi-carrier TN/NTN cell operating in a supplementary UL mode and the UE supports operation in a multi-carrier TN/NTN cell for the given band combination, UE determines what carrier to use for the random access by comparing the measured RSRP of the detected SSB with a carrier-selection threshold also provided as part of the multi-carrier cell system information.

In this case, the determination by the UE of which UL carrier to use for carrying out initial access (e.g., sending preamble) can be based on comparing a measurement of RSRP for a selected SSB against a TN/NTN carrier selection threshold provided by the cell system information via common signaling (e.g., MIB/SIB1). Threshold can be common across the DL carriers or dependent on the DL carrier where the selected SSB is detected, i.e., there can be a different threshold set for each carrier (e.g., a threshold for TN carriers, Th_{TN}, and another threshold for NTN carrier, Th_{NTN}).

If RSRP of detected SSB_TN is lower than Th_{TN}, the UE selects the NTN carrier for carrying out initial access, otherwise, the UE selects the TN carrier for carrying out initial access.

If RSRP of detected SSB_NTN is lower than Th_{NTN}, the UE selects the TN carrier for carrying out initial access, otherwise, the UE selects the NTN carrier for carrying out initial access.

In case of a DL shared carrier, the threshold is a common threshold. If RSRP of detected SSB is lower than Th_{common}, the UE selects the TN carrier for carrying out initial access, otherwise the UE selects the NTN carrier for carrying out initial access.

Random access Message 3 may be transmitted on the same selected carrier without regard to the multi-carrier cell operates in a UL carrier aggregation mode or a supplementary UL mode.

For a UE in RRC Connected mode/state, the UL carrier to use for carrying out random access can be explicitly configured to the UE via Layer 3 RRC signaling.

The technical benefits of this embodiment are as follows: integrating different carrier types (e.g., TN and NTN) into a single, multi-carrier serving cell; cell management simplification; and reduced access delay.

In the following embodiment, we describe an example of enabling carrier-specific initial BWP after initial access to the multi-carrier cell.

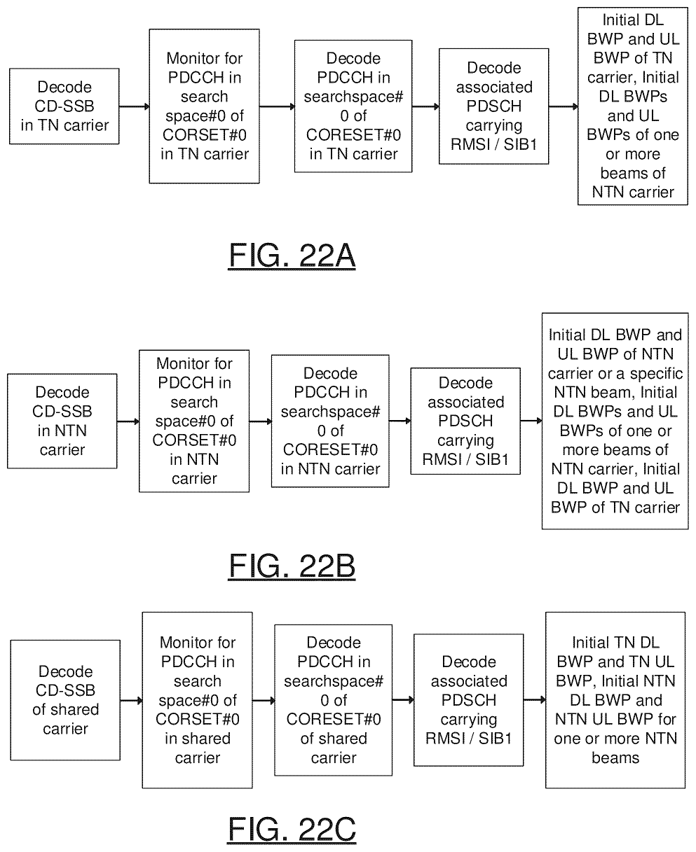

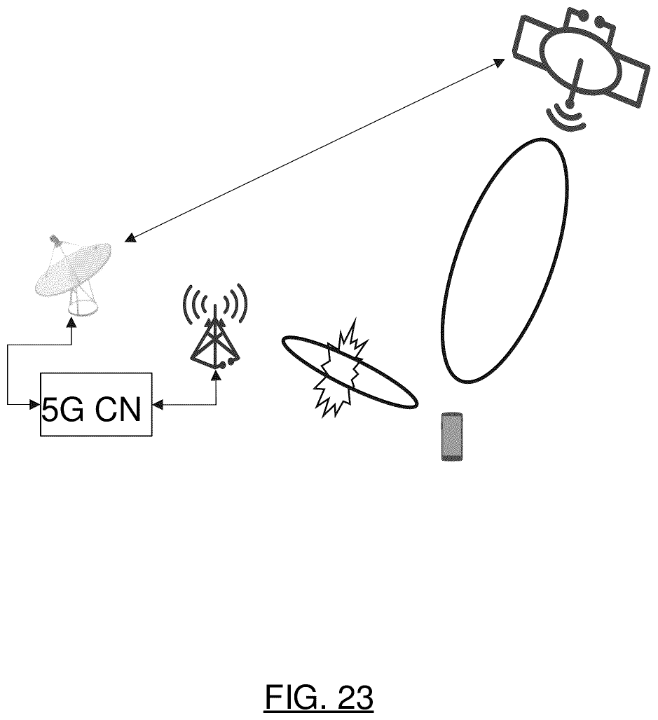

For option 1-1 (two physical DL carriers, see FIG. 15), CD-SSBs are transmitted in one or more DL carriers. FIGS. 19A and 19B illustrate steps in respective methods, for carrying out at a UE, of determining initial bandwidth parts (BWPs). When the UE detects a CD-SSB in one of the DL carriers, the UE extracts the configuration of CORSET #0 and associated search space zero for its own carrier or a specific-beam of the carrier. The UE then decodes the PDCCH and associated PDSCH carrying the RMSI (SIB1) transmission. The RMSI will contain not only the initial DL BWP and UL BWP for the corresponding carrier (e.g., a TN carrier in FIG. 22A, an NTN carrier in FIG. 22B) but also the initial DL BWP and initial UL BWP for all the beams as well as the initial DL BWPs and initial UL BWPs of all the NTN beams of the other carrier (e.g., the NTN carrier in FIG. 22A, the TN carrier in FIG. 22B).

For option 1-2 (shared carrier, see FIG. 16), one CD-SSBs is transmitted on the shared carrier. FIG. 22C illustrates steps in a method, for carrying out at a UE, of determining initial bandwidth parts (BWPs). When UE detects a CD-SSB, it extracts the configuration of CORSET #0 and associated search space zero for the shared carrier or a specific-beam of the shared carrier, then decode the PDCCH and associated PDSCH carrying the RMSI (SIB1) transmission. The RMSI will contain the initial TN DL BWP and initial TN UL BWP as well as the initial NTN DL BWP and initial NTN BWP for all the NTN beams in the shared carrier.

The technical benefit of this embodiment is that the RMSI/SIB1 information in one carrier indicates initial UL and DL BWP for another carrier of the multi-carrier cell, so that the UE can avoid the need to receive RMSI/SIB1 from another carrier/BWP/beam of the multi-carrier cell. This enables the UE to quickly and efficiently access all resources of the multi-carrier cell.

In the following embodiment, we describe an example embodiment for PUSCH/PUCCH transmission using either options 1 or 2.

If the serving cell is a multi-carrier TN/NTN cell operating in a supplementary UL mode and the UE supports operation in a multi-carrier TN/NTN cell for the given band combination, then, for PUCCH transmission, the UE can be configured by means of RRC signaling on which UL CC to transmit PUCCH including ACK/NACK feedback, which can be joint or separate ACK/NACK feedback corresponding to separate DL carriers.

If the serving cell is a multi-carrier TN/NTN cell operating in a supplementary UL mode and the UE supports operation in a multi-carrier TN/NTN cell for the given band combination, then, for PUSCH transmission, the UE can be configured by means of RRC signaling to transmit PUSCH on the same CC as PUCCH. The UE can also be configured via RRC signaling to dynamically select which UL CC to use for PUSCH. The UL grant (PDCCH) can include an indication of which CC is selected for the scheduled PUSCH.

If UE is to transmit UCI on PUCCH on a UL CC (e.g., TN or NTN) during a time interval that overlaps with a scheduled PUSCH transmission on either UL carrier, UE multiplexes UCI onto PUSCH.

The technical benefit of this embodiment is that the UE can dynamically switch between UL carriers for transmitting PUSCH and also multiplex PUSCH and PUCCH in case the transmissions happen to overlap in the time domain.

In the following embodiment, we describe an example embodiment of Carrier Type/BWP Operation using the multi-carrier cell.

Within the multi-carrier cell, the UE can be configured with multiple UL/DL bandwidth parts (BWPs) belonging to the different carrier types (e.g., TN carrier type and NTN carrier type). For example, the UE can be configured with at least 1 active TN DL BWP and 1 active NTN DL BWP. The UE can dynamically switch from one active TN BWP to one active NTN BWP and vice versa.

The carrier type can be one parameter in BWP configuration or can be associated with a certain BWP configuration. For example, if the carrier type is NTN, some BWP parameters can take on default parameters or the BWP may comprise different parameters (e.g., timing offset). For the NTN carrier type, the UE can be configured with one or multiple beam-specific BWPs. A beam-specific BWP is associated with a certain beam direction. A beam direction can be a receive beam direction associated with a certain TCI state. A beam direction can be a transmit beam direction/angle, for example, a direction/angle specified in terms of peak direction (e.g., elevation angle and azimuth angle) and half-power beamwidth (HPBW), as well as polarization indication (RHCP, LHCP).

If the cell is a multi-carrier TN/NTN cell and the UE supports operation in a multi-carrier TN/NTN cell for the given band combination, within the multi-carrier TN/NTN cell, the UE can be configured with a UE-specific/dedicated DL/UL BWP for receiving/transmitting data on the TN carrier and a beam-specific BWP for transmitting/receiving data on the NTN carrier simultaneously.

A dedicated UE-specific BWP or beam-specific BWP can be configured to a UE served by a drone (UAV) TRP. The BWP can belong to a physical carrier (TN or NTN) or virtual carrier.

The technical benefit of this embodiment is an enablement of configuration, simultaneous operation and dynamic switching between different BWPs belonging to different carrier types within a multi-carrier serving cell.

In the following embodiment, we describe two example embodiments of BFR using the multi-carrier cell.

A multi-carrier TN/NTN cell may be shown to allow for fast recovery after experiencing a radio link (RL) or beam failure detection. For example (see FIG. 21), assume a BF is detected on a BWP in the TN carrier, then, instead of going through the cumbersome BFR procedure on the TN carrier, the UE can directly indicate the selected RS to the network through the multi-carrier TN/NTN cell or feedback a measurement report on a set of RSs through the multi-carrier TN/NTN cell. The TN TRP can then directly resume data transmission to the UE using the indicated preferred beam/RS thereby saving on latency and avoiding data interruption.

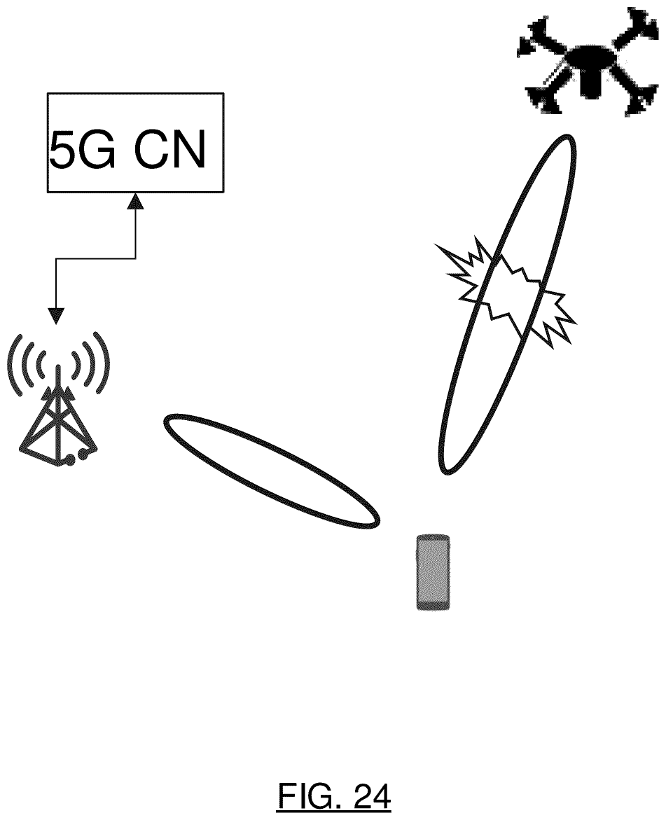

For another example (see FIG. 24), assume a BF is detected on a BWP in the NTN carrier, then, instead of going through the cumbersome BFR procedure on the NTN carrier, the UE can directly indicate the selected RS to the network through the multi-carrier TN/NTN cell or feedback a measurement report on a set of RSs through the multi-carrier TN/NTN cell. The NTN TRP can then directly resume data transmission to the UE using the indicated preferred beam/RS thereby saving on latency and avoiding data interruption.

Another embodiment is to introduce a cross-carrier or cross-BWP BFR procedure within the multi-carrier TN/NTN cell, which procedure is not supported by current NR specifications. Even cross-BWP within a single cell is not supported by current NR specifications. Configuration of candidate RSs (i.e., q₁) comprising RSs located within multiple BWPs of the multi-carrier cell (e.g., TN BWP and NTN BWP) may involve defining measurement gaps for the UE to measure candidate RSs outside the active BWP or active carrier within the multi-carrier cell. The PRACH resource associated with the candidate RSs (q₁) may be defined outside the active BWP or outside the carrier (e.g., TN BWP/Carrier→NTN BWP/Carrier). BFR search space recoverySearchSpace is monitored by the UE to receive the BFR Response using the requested recovery beam, q_{new}, outside the active BWP/carrier (e.g., TN BWP/carrier→NTN BWP/carrier). Monitoring starts from time slot n+4(+K), where n is the time slot where the BFR request is sent and K is a timing gap, which takes into account the propagation delay difference between the TN and the NTN.

The technical benefit of this embodiment relates to fast BFR within the multi-carrier cell thanks to the fact beam failure may not happen simultaneously in all BWPs/carriers belonging to the multi-carrier cell.

In the following embodiment, we describe an embodiments for shared carrier operation.

In case of a shared carrier, TN and NTN can operate in different frequency resources of the shared carrier (see FIG. 25A) at the cost of some performance degradation in terms of latency and lack of flexibility in assigning resources to the UE. For example, the TN and the NTN may be configured to operate on non-overlapping UL or DL BWPs.

For TN and NTN to operate on the same frequency resources (e.g., shared BWP, see FIG. 25B), the UE is indicated, through dynamic signaling (MAC CE or DCI) or RRC signaling (common signaling or dedicated signaling), whether a particular frequency band is shared between TN and NTN. The TN and the NTN use orthogonal pilots. The NTN uses common pilots, the configuration of which is signaled to all the UEs in the multi-carrier cell through RRC broadcast signaling. The UE can use the common pilot configuration to receive the NTN channels. In case the NTN PDSCH overlaps in frequency with TN PDSCH, the UE can jointly decode the two PDSCHs while cancelling the interference from the NTN PDSCH using the common pilot configuration.

The technical benefits of the embodiment relate to carriers of different types (e.g., TN/NTN) sharing the same carrier bandwidth.

In review, a multi-carrier cell may be shown to allow alleviation of delay problems associated with multi-cell CA/DC operation. After the UE gets access to the multi-carrier cell, there is no longer a need for adding/releasing or activating component carriers as in CA framework. This has latency and overhead reduction benefits.

Other benefits relate to efficient utilization of spectrum resources and dynamic allocation of large bandwidth from different carriers to the UE.

Other benefits relate to UE mobility within the multi-carrier TN/NTN cell relying upon layer L1/L2 beam management and signaling instead of Layer-3 handover.

Other benefits relate to network side energy saving and more efficient resource usage being achieved since network can decide to send SSB/system information (RMSI/SIB/OSI) through TN or NTN carrier but not both.

When the integrated carrier comprises an association between a TN and an NTN carrier, efficient and low latency beam failure recovery can be conducted through the TN carrier if the beam or radio link failure occurs in the TN carrier and vice versa if the beam or radio link failure occurs in the NTN carrier.

When the multi-carrier cell comprises one TDD and one FDD carrier, the delay in UL of the TDD carrier due to the TDM between UL and DL slots in the TDD carrier can be alleviated since UL slots in the FDD carrier can be used instead, which is important for URLLC scenarios.

Notably, in a CA/DC framework, the UE first connects to a single serving cell and is configured to carry out measurements on other cells/frequencies, report measurements to the network, then be configured to operate in CA/DC mode. This results in large delays which limit the efficient utilization of spectrum resources and the dynamic allocation of large bandwidth from different carriers to the UE.

In RRC_IDLE or RRC_INACTIVE states, the UE camps on a single cell, which is usually the one from which the UE is able to detect the largest SSB RSRP, so that both the UE and the network are not aware of other potential cells/carriers that the UE could use for CA/DC operation.

It is known that, typically, the UE needs to transition to RRC_CONNECTED state before being configured to measure and report measurements on other cells/carriers, only then will the network be able to configure the UE to operate in CA/DC mode, which causes even more delays and limits the efficient spectrum utilization.

The multi-carrier cell proposed herein may be shown to alleviate delay problems referenced hereinbefore, since the UE directly connects to the multi-carrier cell with multiple band configurations (e.g., a TN band configuration and an NTN band configuration).

When the UE connects to the multi-carrier cell, the UE can directly operate in a CA/DC framework, thereby alleviating all the delay problems associated with multi-cell CA/DC operation.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method, carried out at a device, the method comprising:
receiving a control signal indicating a parameter related to a link of a first link type;
determining, based on the parameter, a subset of resources among a set of resources in a shared resource, the subset of resources reserved for carrying physical signals or channels associated with the first link type and declared as not available to carry physical signals or channels associated with a second link type; and
receiving a downlink signal associated with a link of the second link type over the set of resources excluding the subset of resources.

2. The method of claim 1, wherein the set of resources comprises:
resources that are reserved for reception of a physical downlink shared channel associated with the second link type; or
resources that are reserved for transmission of a physical uplink shared channel associated with the second link type.

3. The method of claim 1, further comprising receiving a configuration indicating that the set of resources comprises control resource sets configured to the device for receiving physical control channels associated with the first link type or the second link type.

4. The method of claim 3, wherein the receiving the configuration comprises receiving the configuration via user equipment (UE)-specific radio resource control signaling.

5. The method of claim 1, wherein receiving the downlink signal comprises rate matching around the subset of resources reserved for carrying physical signals or channels associated with the first link type.

6. The method of claim 5, wherein the rate matching is carried out at the resource element (RE) level or resource block (RB)-symbol level.

7. The method of claim 1, wherein the control signal further indicates a reference signal configuration.

8. The method of claim 7, further comprising basing the determining of the subset of resources on the indicated reference signal configuration.

9. A method comprising:
determining a subset of resources among a set of resources in a shared resource, the subset of resources reserved for carrying physical signals or channels associated with a first link type and declared as not available to carry physical signals or channels associated with a second link type;
transmitting a control signal indicating a parameter related to a link of the first link type; and
transmitting a downlink signal associated with a link of the second link type over the set of resources excluding the subset of resources.

10. The method of claim 9, wherein the set of resources comprises:
resources that are reserved for transmission of a physical downlink shared channel associated with the second link type; or
resources that are reserved for reception of a physical uplink shared channel associated with the second link type.

11. An apparatus comprising:
a memory storing instructions; and
at least one processor caused, by executing the instructions, to:
receive a control signal indicating a parameter related to a link of a first link type;
determine, based on the parameter, a subset of resources among a set of resources in a shared resource, the subset of resources reserved for carrying physical signals or channels associated with the first link type and declared as not available to carry physical signals or channels associated with a second link type; and
receive a downlink signal associated with a link of the second link type over the set of resources excluding the subset of resources.

12. The apparatus of claim 11, wherein the set of resources comprises:
resources that are reserved for reception of a physical downlink shared channel associated with the second link type; or
resources that are reserved for transmission of a physical uplink shared channel associated with the second link type.

13. The apparatus of claim 11, further comprising receiving a configuration indicating that the set of resources comprises control resource sets configured to the device for receiving physical control channels associated with the first link type or the second link type.

14. The apparatus of claim 13, wherein the receiving the configuration comprises receiving the configuration via user equipment (UE)-specific radio resource control signaling.

15. The apparatus of claim 11, wherein the receiving the downlink signal comprises rate matching around the subset of resources reserved for carrying physical signals or channels associated with the first link type.

16. The apparatus of claim 15, wherein the rate matching is carried out at the resource element (RE) level or resource block (RB)-symbol level.

17. The apparatus of claim 11, wherein the control signal further indicates a reference signal configuration.

18. The apparatus of claim 17, further comprising basing the determining of the subset of resources on the indicated reference signal configuration.

19. An apparatus comprising:
a memory storing instructions; and
at least one processor caused, by executing the instructions, to:
determine a subset of resources among a set of resources in a shared resource, the subset of resources reserved for carrying physical signals or channels associated with a first link type and declared as not available to carry physical signals or channels associated with a second link type;
transmit a control signal indicating a parameter related to a link of the first link type; and
transmit a downlink signal associated with a link of the second link type over the set of resources excluding the subset of resources.

20. The apparatus of claim 19, wherein the set of resources comprises:
resources that are reserved for transmission of a physical downlink shared channel associated with the second link type; or
resources that are reserved for reception of a physical uplink shared channel associated with the second link type.
